(19) United States
(12) Patent Application Publication
(10) Pub. No.: US 2026/0079315 A1
(43) Pub. Date: Mar. 19, 2026

(54) Detectable Fiber Optic Cable Protector

(71) Applicant: EAS IP, LLC, Arvonia, VA (US)

(72) Inventors: Ryan C. Dunn, Charlottesville, VA (US); Joshua M. Parman, Palmyra, VA (US)

(73) Assignee: EAS IP, LLC, Arvonia, VA (US)

(21) Appl. No.: 19/335,850

(22) Filed: Sep. 22, 2025

Related U.S. Application Data
(63) Continuation-in-part of application No. 18/636,230, filed on Apr. 15, 2024.
(63) Continuation-in-part of application No. 16/584,913, filed on Sep. 26, 2019, now Pat. No. 12,422,059.
(63) Continuation-in-part of application No. 18/281,562, filed on Jan. 1, 0001, now abandoned.

(51) Int. Cl. G02B 6/44

(52) U.S. Cl. CPC G02B 6/443; G02B 6/4482

(57) ABSTRACT

An open, elongated, marked sheath for fiber optic cable protection is disclosed which permits a length of fiber optic cable to be installed within the sheath. The sheath is marked to indicate that the sheath contents are fiber optic cable and not copper so that the sheath assembly with the fiber optic cable installed may be safely laid out on the ground surface before final burial. The open, elongated, marked sheath is also provided with a remote locating device so that the buried sheath/fiber optic cable assembly can be remotely detected and mapped from the surface after burial underground.

### CROSS REFERENCE TO RELATED APPLICATIONS

This application is a Continuation-In-Part of commonly owned applications Ser. No. 18/636,230, filed on 15 Apr. 2024, Ser. No. 18/281,562 filed 11 Sep., 2023. and Ser. No. 16/584,913, filed 26 Sep. 2019.

### GOVERNMENT SUPPORT

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### BACKGROUND OF THE INVENTION

This invention is directed in general to the protection of infrastructure which is designed to be buried underground. The Meriam Webster™ Online Dictionary defines “infrastructure” as “the system of public works of a country, state, or region” and also as “the resources (such as personnel, buildings or equipment) required for an activity. ” Infrastructure herein, is intended by applicants to include anything which may be required for public works but, in particular, any type of equipment or structure required for public works which may be required to be, or generally is, buried underground. Applicants will refer to such equipment or structure(s) as “buried infrastructure. ” Many of the types of equipment or structures used as buried infrastructure are also elongated. For example, electric power lines, petrochemical lines or pipes, natural gas pipelines, communications structure—such as fiber optic cable or other communications cables, potable water lines, sewer lines and storm water run-off lines,, etc., etc. It is noted that this list is not exhaustive of the various types of buried infrastructure nor is it intended to be. In certain circumstances, an elongated buried infrastructure is temporarily laid out above ground prior to burial. Though the invention is clearly usable with other types of elongated buried infrastructure, the preferred embodiment of the invention is designed to protect wire or cable-like elements which are intended to be buried underground. Specifically, it is directed to theft protection for fiber optic cables which have been or may be laid out on the ground surface and temporarily left there before burial.

In the building industry it is not uncommon for a fiber optic cable contractor to lay out fiber optic cable runs and temporarily leave them on the soil surface before burying the cable. Sometimes, theft occurs before the fiber optic cable can be buried-often because the thieves think the cable contains copper.

The inventors have developed an anti-theft device which can be used in this situation. The device comprises an envelope-like sheath into which the laid-out fiber optic cable, or any similar elongated structure, can be easily installed. The sheath may be clearly marked to indicate that the cable therein is fiber optic cable and does not contain copper. Obviously, if the sheath is not intended for fiber optic cable protection but intended for use with some other type of infrastructure, the indicia thereon may well have a different content.

### BRIEF SUMMARY OF THE INVENTION

This invention comprises an open, elongated, envelope-like sheath [hereinafter the “open sheath”] which is closed along each side and which has an open proximal end and an open distal end at each end of said open sheath and further comprising an open sliding space connecting the open proximal end and the open distal end. An elongated, flexible, strong and generally non-stretchable core material [hereinafter “the core material”] is contained within this open sliding space and extends from the open proximal end to the open distal end. The open sheath may be imprinted with anti-theft indicia to indicate that the open sheath contains only fiber optic cable and does not contain copper. It is obvious that the open sheath may also be imprinted with any other type of indicia which is desirable for a particular intended use which use might be different from that of the herein disclosed preferred embodiment. The core material desirably extends slightly beyond both the proximal end and the distal end of the open sheath. The core material extending from the proximal end of the open sheath may be tied to the front end of a fiber optic cable, or any similar elongated structure, so that the fiber optic cable, or any similar elongated structure, may then pulled into the open sheath by pulling on the portion of the core material extending from the distal end of the open sheath. In this manner, the fiber optic cable [or similar elongated structure] may be pulled through the open sliding space or the open sheath. As noted above, the open sheath may have the aforementioned markings thereon to alert individuals that the open sheath only contains fiber optic cable and does not contain copper [or any other types of markings, as desired]. At a later time, when the contractor is ready to bury the fiber optic cable, or other similar structure, the entire open sheath assembly with the fiber optic cable, or other similar structure, inside can be buried thus giving extra protection for the fiber optic cable, or other similar structure, from the elements and damage which may be caused by contact with the ground [moisture, mechanical abrasion, chemical action, etc., etc.]. It is envisioned that the open sheath may also have remote locating device(s) installed therein so that the buried open sheath may be detectable [locatable] remotely from the surface after it has been buried.

### BRIEF DESCRIPTION OF THE DRAWINGS

FIG. 1 shows a plan view of a first embodiment of the inventive detectable open, elongated, marked sheath [hereinafter the “open sheath”] of the invention.

FIG. 2 shows a cross-sectional view of the open sheath of FIG. 1 taken along section line A-A in FIG. 1.

FIG. 3 shows a second embodiment of the invention.

FIG. 4 shows a first generic strip and components of this strip.

FIG. 5 illustrates elements of the top surface of a second generic strip.

FIG. 6 shows a partial side view of the strip of FIG. 5 taken along the direction of Arrow F in FIG. 5.

FIG. 7 illustrates the bottom surface of the strip of FIG. 5 taken along the direction of Arrow G in FIG. 5.

FIG. 8 shows a first modification of the embodiment of the invention as shown in FIG. 2.

FIG. 9 illustrates a second modification of the embodiment of the invention shown in FIG. 2.

FIG. 10 shows another modification of the embodiment of the invention shown in FIG. 2.

FIG. 11 illustrates a modification of the second embodiment of the invention shown in FIG. 3 taken along section line B-B of FIG. 3.

FIG. 12 shows a prior art marker tape taken from Allen et al., U.S. Pat. No. 3,633,533.

FIG. 13 shows a second prior art marker tape taken from Allen et al., U.S. Pat. No. 3,633,533.

FIG. 14 shows a third prior art marker tape taken from Allen et al, U.S. Pat. No. 3,633,533.

FIG. 15 shows a cross section of the prior art marker tape shown in FIG. 14 taken along section line C-C of FIG. 14.

FIG. 16 shows a prior art marker tape installation taken from Southworth, Jr., U.S. Pat. No. 3,568,626.

FIG. 17 shows a cross-section of the prior art marker tape installation shown in FIG. 16 taken along section line D-D shown in FIG. 16.

FIG. 18 shows a detailed view of the prior art marker tape, 314, 314′ shown in FIGS. 16 and 17 taken from Southworth, Jr. U.S. Pat. No. 3,568,626.

FIG. 19 shows a second embodiment of the prior art marker tape of Southworth, Jr. U.S. Pat. No. 3,568,626 taken from the Southworth, Jr. patent.

FIG. 20 shows a cross sectional view of a prior art buried infrastructure installation with the buried infrastructure protected by a prior art tracer wire.

FIG. 21 shows a plan view of the prior art tracer wire of FIG. 20.

FIG. 22 shows an end view of the prior art tracer wire shown in FIG. 21 taken along arrow H.

FIG. 23 shows a known modification of the prior art tracer wire of FIG. 21.

FIG. 24 shows a prior art magnetomechanical marker taken from Doany et al. U.S. Pat. No. 9,638,822

FIG. 25 shows a cross sectional view of another embodiment of the inventive open sheath similar to that shown in FIG. 11 but which includes an elongated tracer wire.

FIG. 26 shows a blow-up of portion I of FIG. 25.

FIG. 27 shows a plan view of another embodiment of the inventive open sheath incorporating spaced remote locating devices.

FIG. 28 shows a cross-sectional view somewhat similar to FIG. 2 but of the embodiment of the inventive open sheath shown from the point of view of Section J-J of FIG. 27.

FIG. 29 is a plan view of an embodiment of the inventive open sheath incorporating magnetomechanical marker technology.

FIG. 30 is a cross-section of the embodiment shown in FIG. 29 taken from the point of view of section K-K of FIG. 29.

FIG. 31 shows a plan view of another embodiment of the inventive open sheath incorporating different widths for the upper protective layer and the lower protective layer and also incorporating multiple remote locating devices.

FIG. 32 is a cross-sectional of the embodiment shown in FIG. 31 taken from the point of view of section M-M of FIG. 31.

FIG. 33 shows a strip with side edges and a centerline with an elongated core material positioned thereon to one side of the strip centerline with the strip in a flat configuration ready to be folded about the strip centerline to form an open, protective envelope.

FIG. 34 shows the strip shown in FIG. 33 after the strip has been partially folded about the strip centerline.

FIG. 35 shows the strip shown in FIG. 33 after the strip has been folded further about the strip centerline than the showing of FIG. 34.

FIG. 36 shows the strip shown in FIG. 33 after the strip has been almost completely folded further about the strip centerline.

FIG. 37 shows the strip shown in FIG. 33 after the strip has been completely folded about the strip centerline.

FIG. 38 shows an end view of the strip shown in FIG. 37 taken along section line O-O as shown in FIG. 37.

### DETAILED DESCRIPTION OF THE INVENTION

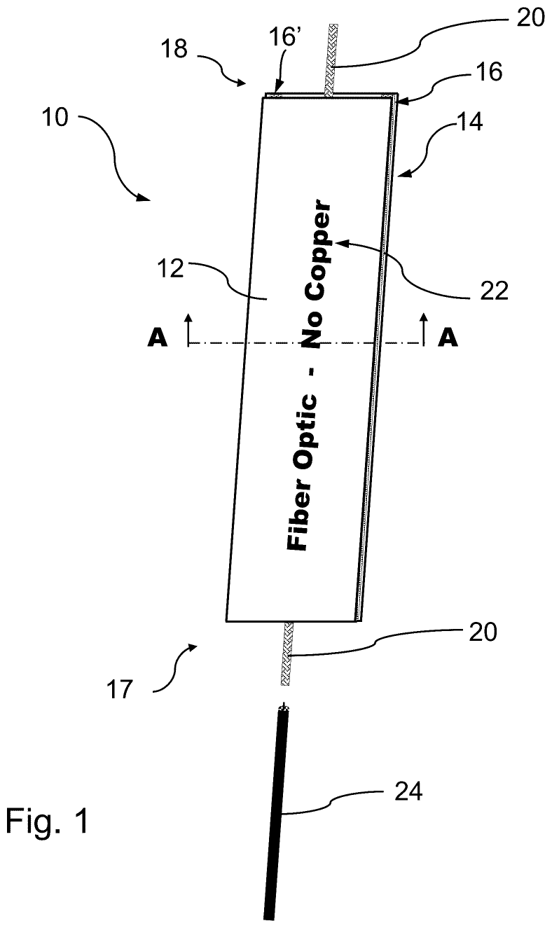

FIG. 1 shows a plan view of the detectable, open, elongated, envelope-like marked sheath 10 [hereinafter the “open sheath 10] of the invention. Open sheath 10 comprises an upper protective material layer 12 comprising a first strip with a first length and a first width which is superposed with and joined to lower protective material layer 14 which comprises a second strip which second strip has a second length and a second width. It is noted that lower protective material layer 14 is not easily visible in FIG. 1 even though the numeral 14 and a lead arrow are shown in FIG. 1. For simplicity and clarity, the upper protective material layer 12 comprising a first strip with a first length and a first width will hereinafter be referred to as “upper strip 12” and the lower protective material layer 14 which comprises a second strip with a second length and a second width will hereinafter be described as “lower strip 14.” The outside [or upper] surface of upper strip 12 may have anti-theft indicia 22 or other suitable indicia, as desired, applied thereon which indicia may indicate that elongated sheath 10 contains only fiber optic cable and contains no copper. It is to be understood that any reference to indicia hereinafter made in this specification is considered to include any other suitable indicia, as desired for a specific application of the invention, other than protection of a fiber optic cable. Anti-theft indicia 22 may also be placed on the outside surface [the lower surface] of lower strip 14. Of course, it is possible to place anti-theft indicia 22 on the outside surfaces of both upper strip 12 and lower strip 14. It is also noted that anti-theft indicia 22 may be reverse imprinted on the lower [or inside] surface of upper strip 12 if this first strip is transparent or at least partially transparent. Anti-theft indicia 22 could also be reverse imprinted on the upper [or inside] surface lower strip 14 if this strip is transparent or at least partially transparent. It should also be noted that the anti-theft indicia will be repeated and imprinted over the entire length of elongated sheath 10.

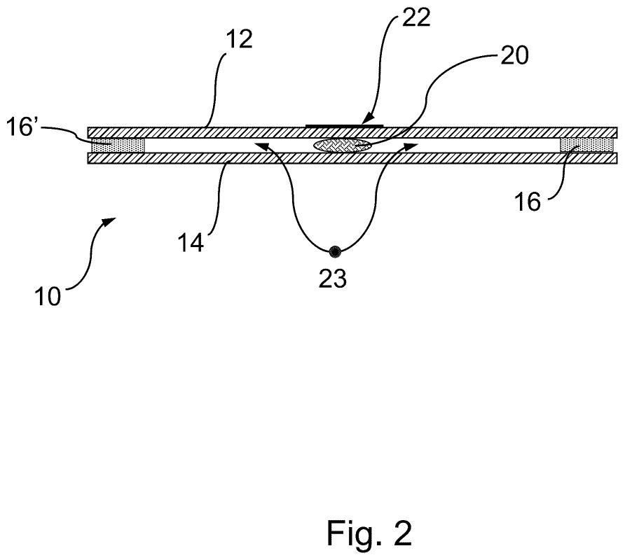

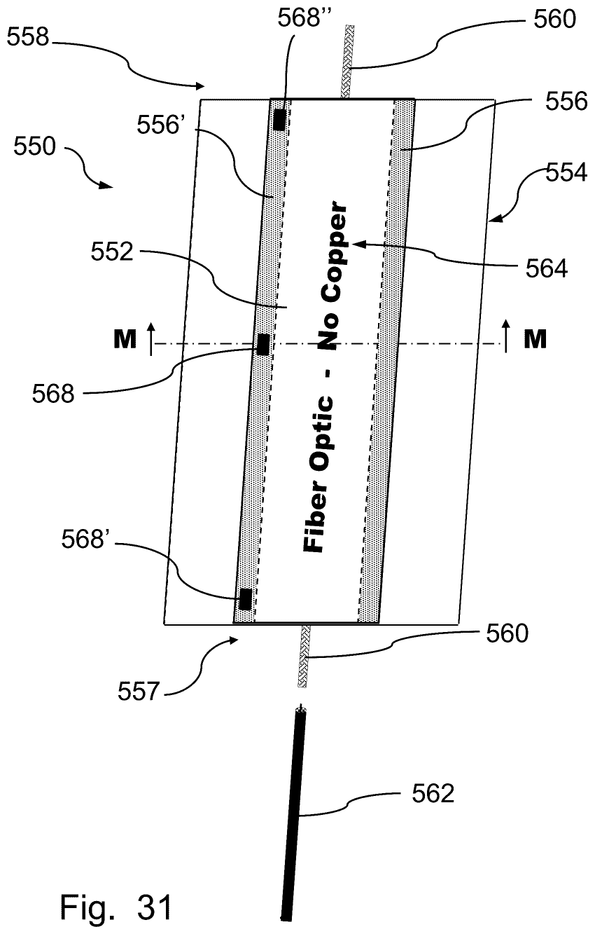

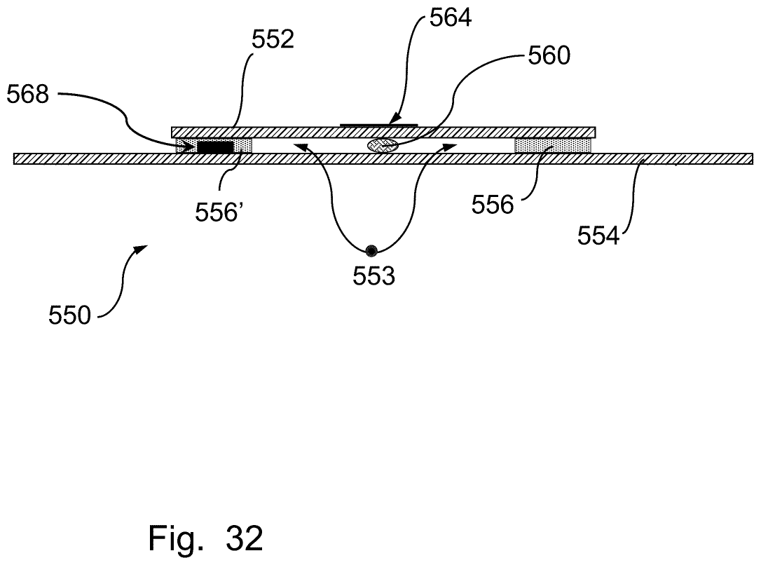

The first length of upper strip 12 is substantially equal to the second length of lower strip 14. The first width of upper strip 12 is preferably substantially equal to the second width of lower strip 14; however, it is noted that the width of upper strip 12 and lower strip 14 do not have to be equal, as will be discussed below in reference to FIGS. 31 and 32. What applicants mean by the lengths being “substantially equal” is that the length of upper strip 12 is equal to the length of lower strip 14 within a few inches, for example, 0 to 10 inches or 0 to 25.4 cm. What applicants mean by the widths being “substantially equal” is that the width of the upper strip 12 is equal to the width of lower strip 14 to within approximately 0-0.5 inches or 0-1.27 cm. This “substantially equal” width limitation, of course, does not apply if one of upper strip 12 or lower strip 14 is deliberately made wider than the other strip as will be discussed below. The strip comprising upper layer 12 and the strip comprising lower layer 14 are joined by adhesive strips 16, 16′. Adhesive strips 16, 16′ are applied to the lower [or inside] surface of upper strip 12 and the upper [or inside] surface of lower strip 14 along the lateral edge portions thereof [note the general discussion of strip elements below.] When upper strip 12 and lower strip 14 are secured together they form open sliding space 23 [shown in FIG. 2]. Adhesive strips 16, 16′ are confined to the outer edge portions of the lower surface of upper strip 12 and the outer edge portions of the upper surface of lower strip 14 which outer edge portions run along the side edges of upper strip 12 and lower strip 14. It is noted that the adhesive strips 16, 16′ may extend all the way to the outer edges of upper strip 12 and lower strip 14 or they may not extend all the way to the outer edges of upper strip 12 and lower strip 14 [as is indicated in FIG. 2]. The important thing is that whatever type of material or structure is used to join the edges of upper strip 12 to the edges of lower strip 14, this joining should form a tight and complete seal so as to keep contaminants out and protect whatever is inside open sheath 10 from damage after burial underground. An open, envelope-like elongated sheath 10 is thus formed with closed sides and an open proximal end 17 and an open distal end 18. Core material 20 is placed in open sliding space 23 of open sheath 10 and is thus free from contact with any adhesive so that core material 20 may freely slide inside the open sliding space of open sheath 10. It will be discussed below how the open sheath 10 is made detectable.

It is noted that core material 20 extends slightly from both proximal open end 17 and open distal end 18 of open sheath 10. That is, the length of core material 20 is slightly longer than the length of upper strip 12 and slightly longer than the length of lower strip 14. What applicants mean by “slightly longer” in this context is that there will be enough of the core material extending from the open ends on both open proximal end 17 and open distal end 18 to permit the extending core material 20 to be conveniently handled such as to pull on it or to tie core material 20 to a fiber optic cable [or similar elongated structure]. Thus the core material would need to extend about 6 to 12 inches [15.24-30.48 cm] from each open end of elongated, marked sheath 10. Obviously, this core material extension could be greater or less than these disclosed values depending upon the exact application of the invention. The disclosed dimensions are presented solely for example in the preferred embodiment and not intended as limiting. A portion of a fiber optic cable 24 is shown aligned with the end of core material 20 extending from proximal end 17 of open sheath 10.

It is noted that open sheath 10 will be much longer than it is wide. Fiber optic cable runs may well be a thousand feet long [or longer]—so open sheath 10 would also have to be of a similar length. It is envisioned that for ease of installation of the fiber optic cable inside open sheath 10, it may be desirable to break up a long run of open sheath 10 into several shorter runs which can be joined together in order to provide for shorter working lengths of open sheath 10—say lengths of one or two hundred feet or more such that it will be easier to pull the fiber optic cable into and through open sheath 10.

If a fiber optic cable contractor finds it necessary or convenient to lay out the fiber optic cable on the surface of the soil and temporarily leave it there before burial, proximal end 17 of open sheath 10 may be aligned with an end of the fiber optic cable as shown in FIG. 1. The portion of core material 20 extending from proximal end 17 may be tied to the end of fiber optic cable 24 and the fiber optic cable 24 may then be pulled inside and all the way through open sheath 10 by pulling on the end of core material 20 which extends from distal end 18 of open sheath 10. Once fiber optic cable 24 has been pulled into open sheath 10, it is protected against potential theft by open sheath 10 which warns anyone that open sheath 10 only contains fiber optic cable and does not have any copper therein. When the fiber optic cable contractor is ready to bury the cable, the assembled open sheath 10 with fiber optic cable 24 contained inside may be buried thus providing additional protection to fiber optic cable 24 from damage which may be caused by contact with the ground [moisture, mechanical abrasion, chemical action, etc., etc.]. It is noted that fiber optic cable 24 would normally extend somewhat [about 6 to 12 inches or more, as desired, {15.24-30.48 cm or more, as desired,}] from each open end of open sheath 10 after it was pulled into and through open sheath 10 as described above.

Protective material layers 12, 14 may be made from any suitable material. It is envisioned that suitable materials might be thin layers of synthetic plastics, for example, polyethylene, polypropylene, polyvinylidene chloride [e.g. Saran™] or a fluorocarbon. Other suitable materials may also be used. A typical thickness for material layers 12, 14 might be 0.001-0.002 inches [0.00254-0.00508 cm] although other thicknesses may be used, as desired and/or necessary.

Any type of suitable adhesive may be used to make adhesive strips 16, 16′ which are used to join protective material layers 12 and 14 together. It is noted that applicants consider that the process of joining protective material layers 12 and 14 using adhesive may be referred to as “laminating” protective material layers 12, 14 together. It is noted that one of the definitions of the verb “laminate” in the Merriam Webster™ Online Dictionary is “to unite (layers of material) by adhesive or other means”. Applicants consider that these “other means” may include joining processes other than adhesive bonding which may also be referred to as “laminating”. For example, it is possible to “laminate” layers 12, 14 together using adhesive. Since it is envisioned that layers 12, 14 will normally comprise thermoplastic materials, it possible to “laminate” these layers together by heat sealing, ultrasonic welding, or any other suitable joining process. Any process of joining protective material layers 12 and 14 together is acceptable if it will properly seal open sheath 10 against damage which may be caused to whatever is contained within open sheath 10 by contact with the ground, ground water or chemicals, etc., etc. in the ground.

It would also be possible to make open sheath 10 by folding in half a layer approximately twice as wide as the desired width of finished open sheath 10. The fold would be made about the longitudinal center line of this layer. The opposing ends of the folded layer would then be laminated together with adhesive, heat sealing, ultrasonic welding or any other suitable joining process. This technique is described below and in commonly owned published International Application WO 2022 191849 [now filed in the U.S. as application Ser. No. 18/281,562] and illustrated in FIG. 34-38 of the above-noted published International Application.

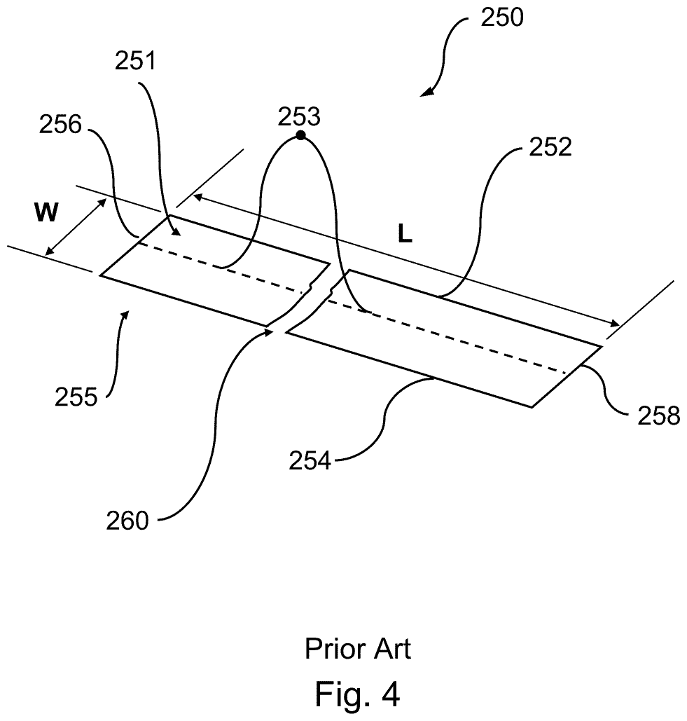

FIG. 2 illustrates a cross-section of open sheath 10 taken along section line A-A of FIG. 1. Upper layer 12 desirably comprises a strip of thermoplastic material with a defined width and length, with a top surface, a bottom surface and side edge portions at each side of the strip of thermoplastic material on both the top and bottom surfaces thereof. These elements are not shown with numerals in FIG. 2 but are readily apparent from the discussion of generic strip terminology which appears below in conjunction with the description of FIG. 4-7. Upper layer 12 is joined to lower layer 14. Lower layer 14 also desirably comprises a strip of thermoplastic material with a defined width and length, with a top surface, a bottom surface and side edge portions at each side of the strip of thermoplastic material on both the top and bottom surfaces thereof. Upper layer 12 and lower layer 14 are joined by adhesive strips 16, 16′ which are only located on the outer edge portions of the strips comprising protective material layers 12, 14. Thus, the bottom surface of upper layer 12 and the top surface of lower layer 14 and the adhesive strips 16, 16′ form open sliding space 23. It is noted that upper layer 12 and lower layer 14 may be made from any suitable material and do not have to comprise thermoplastic materials. Elongated core material 20 is placed generally in the middle of the assembled open sheath 10 in open sliding space 23. It is noted that core material 20 is shown with an oval cross-section in FIG. 2; however, it is obvious that the cross-section of core material 20 may be other than oval, for example, it might be circular, square or rectangular or any other suitable geometric shape. Anti-theft indicia 22 is imprinted upon the upper surface of the strip comprising upper layer 12. It is noted that core material 20 may be made from any suitable material but it is envisioned that core material 20 will be made from a polyester or aramid fiber fabric tape such as the fabric core materials disclosed in commonly owned U.S. patent application Ser. No. 16/331,525, filed as PCT/US2017/050405 on 7 Sep. 2017—now U.S. Pat. No. 12,007,517.

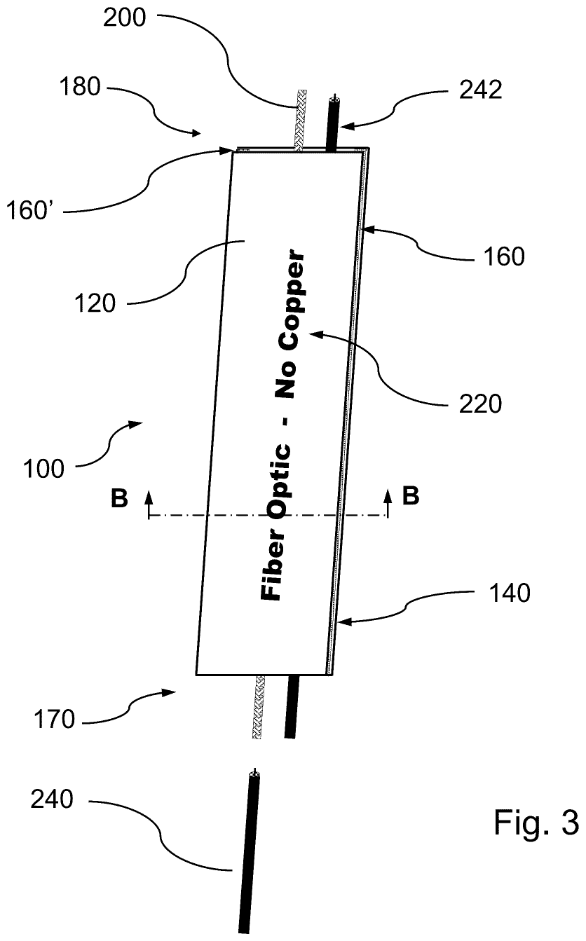

FIG. 3 illustrates a second embodiment of the invention. Elongated, open, envelope-like, marked sheath 100 [hereinafter “open sheath 100”] is shown comprising upper protective material layer 120 which is shown as being joined to lower protective material layer 140 by adhesive strips 160, 160′. Open sheath 100 has an open proximal end 170 and an open distal end 180. An open sliding space [not shown in FIG. 3] is formed by the joined upper protective material layer 120 and lower protective material layer 140. Core material 200 is shown as being threaded through open sheath 100 within the above open sliding space and as slightly extending from open proximal end 170 and open distal end 180. In addition, this embodiment has an elongated section of fiber optic cable 242 already installed inside open sheath 100. Elongated fiber optic cable 242 also slightly extends from open proximal end 170 and open distal end 180 of open sheath 100. It is noted that another fiber optic cable 240 may be pulled through the open proximal end 170 of open sheath 100. Use of this second embodiment permits multiple fiber optic cables to be enclosed within open sheath 100. It is noted that this embodiment only discusses an open sheath 100 which can contain two [2] fiber optic calbes, but it is obvious that open sheath 100 could contain three [3] four [4] or more fiber optic cables, if desired.

Applicants are using strip-like materials to make various components of applicants' anti-theft device. In addition, a number of the physical elements of strip-like materials are being claimed. It is therefore considered desirable to indicate exactly what applicants mean by the use of these elements. FIG. 4 illustrates a first generic strip 250 with a length L, width W, a first side edge 252, a second side edge 254, a leading edge 256 and a trailing edge 258. First and second side edges 252, 254 are generally parallel to each other and form straight lines. It is also noted that first generic strip 250—since it has parallel side edges 252, 254 also has an imaginary centerline 253 which is not actually a visible physical feature in this drawing [as side edges 252, 254 are visible features] and therefore imaginary centerline 253 is illustrated herein with a dotted line. First generic strip 250 also has an upper surface 251 and a lower surface 255. It is noted that lower surface 255 is not visible in FIG. 4 even though the numeral 255 and a lead arrow are shown in FIG. 4. Leading edge 256 and trailing edge 258 may form straight lines and may be parallel to each other or they may not be parallel and may not form straight lines. For convenience in illustrating the invention, strip 250 has been generally shown herein as a parallelogram; however, as long as side edges 252, 254 are generally parallel, there is no necessity for leading edge 256 and trailing edge 258 to be straight lines. There is also no necessity that leading edge 256 and trailing edge 258 be parallel to each other. For example, leading edge 256 and trailing edge 258 could basically have any desired shape-semicircular, oval, jagged or any other shape. It is also to be noted that applicants are using strips which are much longer than they are wide. For example, when manufactured as applicants' anti-theft open, elongated, marked sheath, a typical value for length L for strip 250 could be between 100 and 1000 feet [or approximately 30.5 m-305 m], while a typical value for width W might be between approximately 4 inches and 18 inches [or approximately 10.2 cm-38.1 cm]. It is noted that width W may also be wider than 15 inches [38.15 cm] or narrower than 4 inches [10.2 cm] as desired. For example, if the inventive marker tape is being used to protect a large pipeline, say 30 or more inches [76.2 cm] in diameter, it may be desirable to have a marker tape with a width of 20-30 inches [50.8 cm-78.2 cm] or more, as desired. This is one reason why the interruption 260 is shown in FIG. 4 to indicate that the strip is quite long. When applicants state that the length of a strip is much longer than the width of the strip is wide, they mean that the length is intended to be many, many times longer than the strip is wide. As noted, above, when manufactured, the elongated, marked sheath may be hundreds of feet long [or longer] while the width of the strip will normally be less than about one foot. This is what applicants mean when they say that the length of the strip is much longer than the strip is wide.

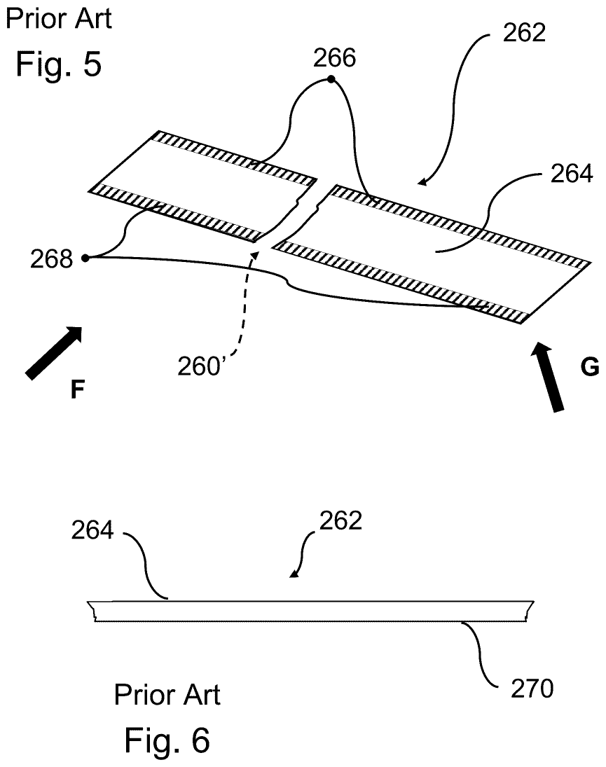

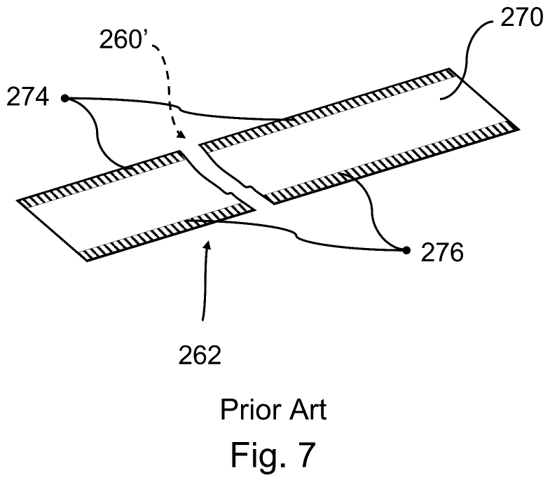

FIG. 5 shows a second generic strip 262 similar to first generic strip 250 with interruption 260′ shown to indicate that strip 262 is much longer than it is wide. It is noted that the lead line for interruption 260′ is dashed for clarity because it had to cross another lead line. Although it should be noted that an interruption such as those shown by 260, 260′ has not always been included in applicants'drawings of strips and the inventive elongated, marked sheath. Second generic strip 262 is shown with a top surface 264 and first side edge portion 266 at one side of top surface 264 and a second side edge portion 268 at the other side of top surface 264. Side edge portions 266, 268 are indicated by shading and will extend somewhat inside the side edges of second generic strip 262 as shown in FIG. 5. FIG. 6 illustrates a partial side view of second generic strip 262 taken along arrow F of FIG. 5. Second generic strip 262 is shown with top surface 264 and bottom surface 270 both being visible in FIG. 6. FIG. 7 is a bottom view of second generic strip 262 taken along arrow G of FIG. 5 and shows bottom surface 270 and first side edge portion 276 at one side edge of bottom surface 270 of second generic strip 262 and second side edge portion 274 at the other side edge of bottom surface 270. As discussed above for FIG. 5, side edge portions 274, 276 are shown by shading in FIG. 7 and extend somewhat inside the side edges of second generic strip 262. Interruption 260′ is also shown in FIG. 7 and, as in FIG. 5, the lead line for interruption 260′ is dashed for clarity.

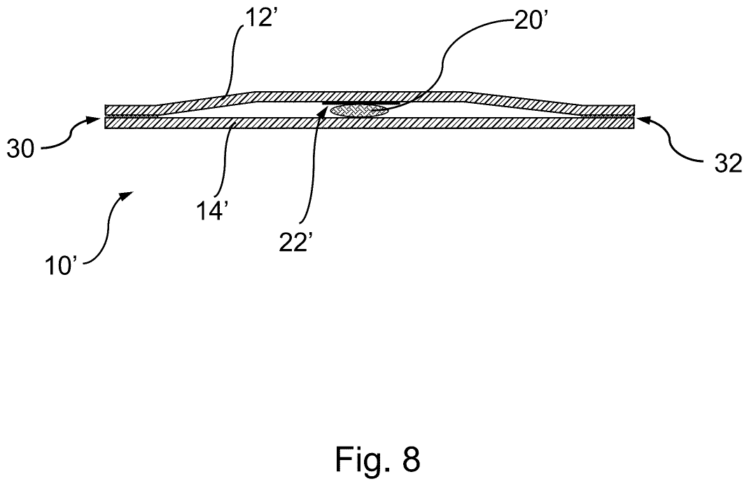

FIG. 8 shows a first modification of the embodiment of the invention shown in FIG. 2. Envelope-like, open, elongated, marked sheath 10′ [hereinafter open sheath 10′] is shown with upper layer 12′ joined to lower layer 14′ by having the side edge portions on the lower surface of the strip comprising upper layer 12′ heat sealed to side portions on the upper surface of the strip comprising lower layer 14′ as shown at 30, 32. It is noted that anti-theft indicia 22′ is reverse imprinted on the lower surface of the strip comprising upper layer 12′ instead of being imprinted on the upper surface of the strip comprising upper layer 12 as shown in FIG. 2. It is further noted that, in this embodiment, at least the portion of upper layer 12′ immediately above anti-theft indicia 22′ would have to be transparent in order for anti-theft indicia 22′ to be visible from outside the elongated sheath 10′. Elongated core material 20′ is slidably contained within upper layer 12′ and lower layer 14′.

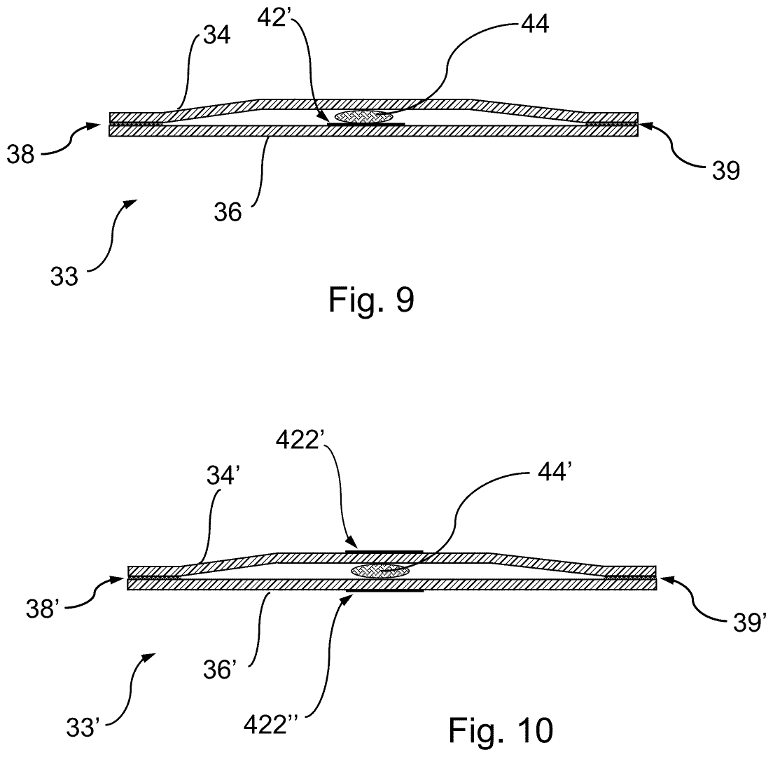

FIG. 9 illustrates a second modification of the embodiment of the invention shown in FIG. 2. Envelope-like, open, elongated, marked sheath 33 [hereinafter open sheath 33] comprises upper layer 34 joined to lower layer 36 by having the side edge portions on the lower surface of the strip comprising upper layer 34 ultrasonically welded to corresponding side portions on the upper surface of the strip comprising lower layer 36 as shown at 38, 39. Anti-theft indicia 42′ is reverse imprinted to the upper surface of the strip comprising lower layer 36. It is further noted that, in this embodiment, at least the portion of lower layer 36 immediately below anti-theft indicia 42′ would have to be transparent in order for anti-theft indicia 42′ to be visible from outside the elongated, marked sheath 33. In addition, elongated core material 44 is slidably contained within upper layer 34 and lower layer 36.

FIG. 10 illustrates a second modification which is similar to but not identical to the embodiment of the invention shown in FIG. 2. Envelope-like, open, elongated, marked sheath 33′ [hereinafter open sheath 33′] comprises upper layer 34′ joined to lower layer 36′ by having the side edge portions on the lower surface of the strip comprising upper layer 34′ ultrasonically welded to corresponding side portions on the upper surface of the strip comprising lower layer 36′ as shown at 38′, 39′. Anti-theft indicia 422′ is imprinted on the upper surface of the strip comprising upper layer 34′ and additional anti-theft indicia 422″′ is imprinted on the lower surface of the strip comprising lower layer 36′. In addition, elongated core material 44′ is slidably contained within upper layer 34′ and lower layer 36′.

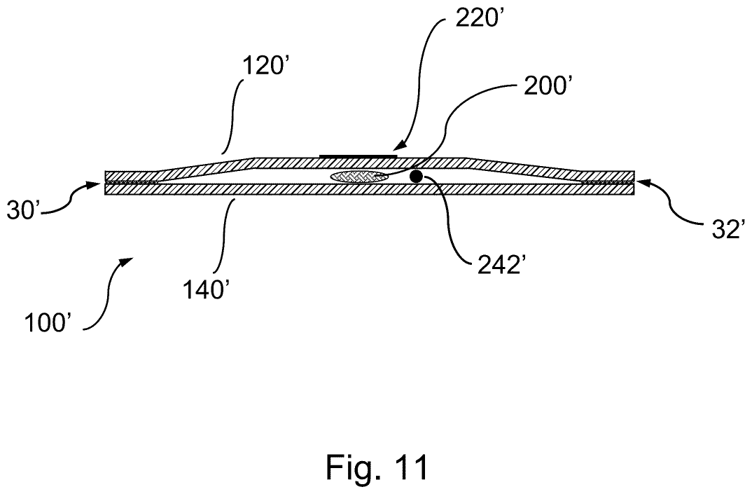

FIG. 11 shows a modification which is similar to but not identical to the embodiment of the invention shown in FIG. 3. A cross-section of this modification is shown herein which is similar to a cross-section of the envelope-like, elongated, marked sheath 100 of FIG. 3. Note that in FIG. 11, elongated core material 200′ is not shown as similar in lateral dimension to fiber optic cable 242′ and that while fiber optic cable 242 and elongated core material 200 are shown in FIG. 3 as being of generally circular cross-section, elongated core material 200′ is shown in FIG. 11 as being oval in cross-section. Envelope-like, open, elongated, marked sheath 100′ [hereinafter open sheath 100′] comprises upper layer 120′ joined to lower layer 140′ by having the side portions on the lower surface of the strip comprising upper layer 120′ heat sealed to corresponding side portions on the upper surface on the strip comprising lower layer 140′ as shown at 30′, 32′. In addition, elongated core material 200′ is slidably contained within upper layer 120′ and lower layer 140′. Anti-theft indicia 220′ is imprinted on the upper surface of the strip comprising upper layer 120′. Elongated core material 200′ is slidably contained within upper layer 120′ and lower layer 140′. In this embodiment a length of fiber optic cable 242′ is also positioned between upper layer 120′ and lower layer 140′ to one side of elongated core material 200′ such that it is possible to pull another length of fiber optic cable [not shown in FIG. 11] into open sheath 100′ using elongated core material 200′ in a similar manner to that described above.

It is desirable to be able to locate, from the surface, the buried elongated, marked sheath containing the fiber optic cable. To this end it is envisioned that one or more buried object locator devices will be incorporated within the elongated sheath such that after the fiber optic cable is installed in the elongated, marked, sheath and the assembly is buried—it would be possible to locate the buried assembly from the surface. The following discussion of Buried Object Locator Technology is taken from Applicants, ′ commonly owned, application Ser. No. 18/281,562, filed 11 Sep. 2023.

### Buried Object Locator Technology

It is very desirable to be able to locate buried infrastructure from the surface before digging and finding the buried infrastructure the hard way—after the excavation equipment has struck and/or damaged the buried infrastructure. It is also, in many instances, much safer to locate the buried infrastructure from the surface before digging. Sadly, fatal accidents occur every year when buried natural gas, petrochemical pipelines, or power lines are unknowingly damaged by excavation equipment. A number of different technologies exist which will permit an object buried in soil to be located and/or mapped from the soil surface. Examples of these known devices include simple tracer wire, RF devices, RFID devices, simple ferrous locating devices, metallic foils, magnetic locating devices, radioactive locating devices, and magnetomechanical locating devices. It is noted that this listing is neither exhaustive of nor is it intended to be exhaustive of prior art types of buried object locator devices and/or technology.

### Marker Tape Technology

The use of marker tape is a well-known method for locating buried infrastructure. The use of marker tape can provide a warning of imminent excavation damage to buried infrastructure such as pipelines, buried power lines, buried communication lines and any other type of buried infrastructure.

Currently, marker tape is the standard protective measure used in new installations of buried infrastructure. Marker tape is a passive visual indicator, which is almost always buried directly above a buried infrastructure. Such an installation is well-known and easily done by infrastructure installation crews. Since the marker tape is almost always buried directly over the buried infrastructure, the marker tape will be struck first by excavation machinery working near the buried infrastructure—hopefully before the excavation machinery can strike the buried infrastructure itself. The idea is that, when the marker tape is struck by excavation equipment, portions of the marker tape will be pulled to the surface or at least to a position in the excavation trench where the portions may be seen so that excavation crews can be warned of the imminent danger to the buried infrastructure. Marker tape comes in a variety of widths and flexible materials. Some contain metallic components such as tracer wire or foil, the purpose of which is to aid in remotely locating—from the surface—the marker tape [and thus the infrastructure—since the marker tape is buried directly over the infrastructure] after it has been installed [i.e., buried underground and above the infrastructure]. Some marker tapes are designed to stretch under the theory that when struck by excavation machinery [usually an excavator bucket], they can be pulled to or near the surface where they can be seen. Obviously, if pulled to the surface, it would be possible for the marker tape to be seen by the excavation crew, especially if the marker tape is brightly colored—as it often is—but it might also be possible for the marker tape to be seen even if it is not pulled completely to the surface. For example, if the marker tape was pulled up into an open trench [but still below the ground surface] it might be possible for the marker tape to be seen in the open trench by a spotter [the excavation crew member charged with keeping an eye on the trench and alerting the backhoe operator to stop digging if anything suspicious is spotted in the trench]. Thus the visible marker tape could alert the excavation crew to the presence of buried infrastructure.

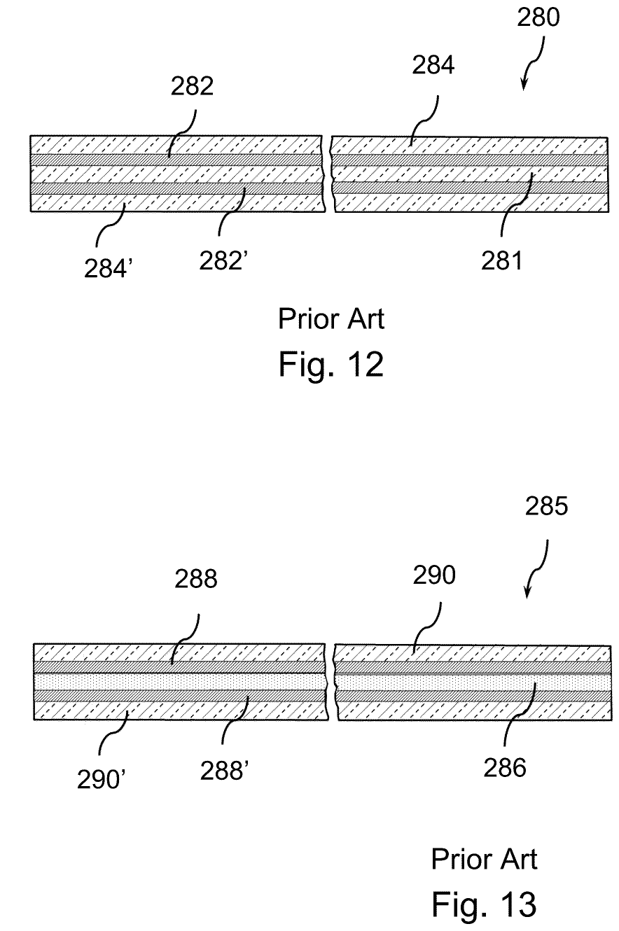

One example of prior art marker tape is disclosed U.S. Pat. No. 3,633,533 issued on 11 Jan., 1972, to Gordon H. Allen et al. [hereinafter Allen '533]. Allen '533 disclosed an early example of marker tape comprising a thin plastic film which may be made, for example, of polyethylene or polypropylene or polyvinylidene chloride [e.g. Saran™] or a fluorocarbon. As shown in FIG. 12 [taken from Allen '533], marker tape 280 may comprise a film 281 which may have a thickness of about 0.001 to 0.002 inch [or 2.54×10⁻³ cm to 5.08×10⁻³ cm]. Each side of film 281 will carry a more or less continuous metallic coating 282, 282′. The metallic coating 282, 282 may, for example, be made of aluminum which may be deposited as a thin film, of the order of a thickness of 0.00005 to 0.0007 inch [or 1.27×10⁻⁴ cm to 1.778 10³ cm] by conventional vacuum deposition techniques. On each of the outside surfaces of the metal-coated film 281 there is a protective coating or film 284, 284′ of synthetic plastic which may, again, be of polyethylene or polypropylene or polyvinylidene chloride [e.g. Saran™] or a fluorocarbon.

The finished marker tape 280 should have a color which contrasts with the color of the earth soil surrounding or adjacent to the buried infrastructure. To this end the film 284, 284′ may have a color such as red, green, yellow, or any suitable other color which would contrast to the color of the earth soil in which the buried infrastructure is emplaced. Alternatively, if the film 284, 284′ is transparent, then the color of the metallic coating 282, 282′ itself may serve the purpose of providing to the finished marker tape 280 with a color contrasting to that of the earth soil. Other procedures, which would be known to one of ordinary skill in this art, may also be used to provide the necessary contrasting color to marker tape 280.

Allen '533 also teaches a marker tape 285 as shown in FIG. 13 [also taken from Allen '533] comprising two thin metallic layers 288, 288′ each of which may have a thickness in the range of about 0.0005 inch [or 1.27 10⁻³ cm], and which are firmly laminated together by a thin film 286 of a laminating adhesive which may be a catalyzed epoxy cement. A thin film 290, 290′ such as the film 284, 284′ shown in FIG. 12 is laminated to each outside surface of the metallic layers 288, 288′. The provision of a color to the finished marker tape 280 [which color is selected to contrast with the color of the earth soil] can be effected in the same manner indicated in connection with the embodiment shown in FIG. 12.

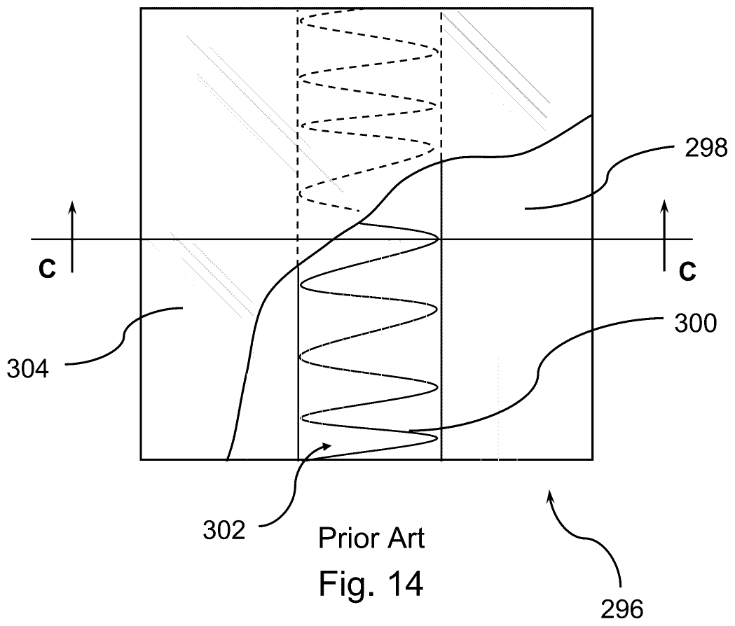

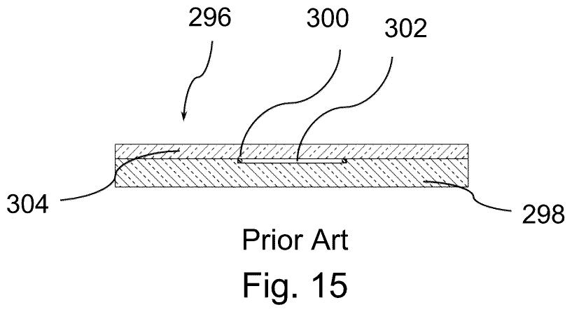

Allen '533 also teaches a marker tape 296 as shown in FIGS. 14 and 15 [also taken from Allen '533] comprising a colored polyethylene or other moisture and soil-resistant synthetic plastic tape 298 which has on its surface a tracer wire 300, for example, made of copper, nickel or a ferrous alloy, in the form of a zigzag arrangement laying in channel 302 cut into the upper surface of plastic tape 298.

Laminated to the upper surface of tape 298 is another tape 304 of colored polyethylene or synthetic plastic. A variant of this embodiment is initially to coat the metallic wire with a protective synthetic plastic or similar material, as by passing the metallic wire through a hot melt of such plastic or material, and then bond said coated wire directly to the marker tape 296 by a passage through heated rollers. This process is a form of heat sealing. It is obvious that there are other methods which can be used to make the Allen '533 marker tape 296. For example, the layers 298 and 304 could be simultaneously extruded around wire 300 in an extrusion process. The purpose of tracer wire 300, is to enable the marker tape 296 to be detected while buried underground using conventional techniques. It is noted that Allen '533 does not teach that his wire 300, is anything other than an electric conductor useful for locating his marker tape while it is still underground. There is absolutely no teaching in Allen '533 that this wire 300, might be a strong core material. Tape 296 is colored and has soil contrasting reflective stripes to aid in tape detection. Allen teaches that the tape will be color coded in the accepted coding for the type of underground infrastructure or utility line being protected. The uniform color code generally accepted in the industry to identify underground facilities is as follows: Red—electric power lines; Yellow—gas, oil or steam lines; Orange—telephone, police and fire communications and cable television; Blue—water lines; and Green—sewer lines.

The purpose of the metallic foil in marker tapes 280 and 285 is to permit the marker tapes to be detected while buried underground by conventional techniques. As noted above, the purpose of the metallic wire 300 in marker tape 296 is also to permit the marker tape to be detected using conventional techniques while buried. It is noted that Allen '533 does not provide thickness dimensions for his tape 296; however, it seems conservative to assume that, absent any disclosure to the contrary, tape 296 is either the same thickness as tape 280, 285 or of a very similar thickness. In effect, metallic wire 300 is functioning as tracer wire in marker tape 296. It is noted that Allen '533 does not teach the use of a strong core material.

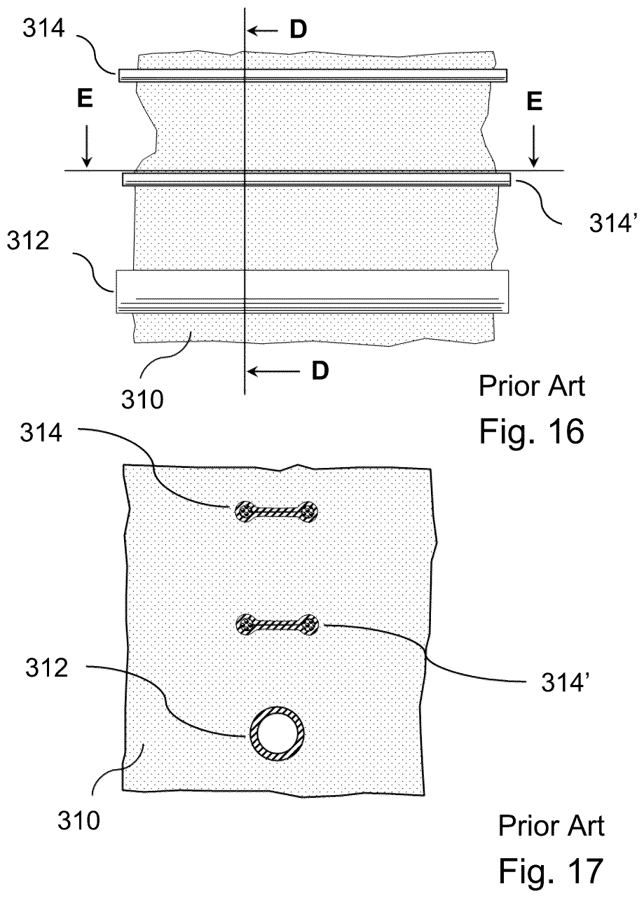

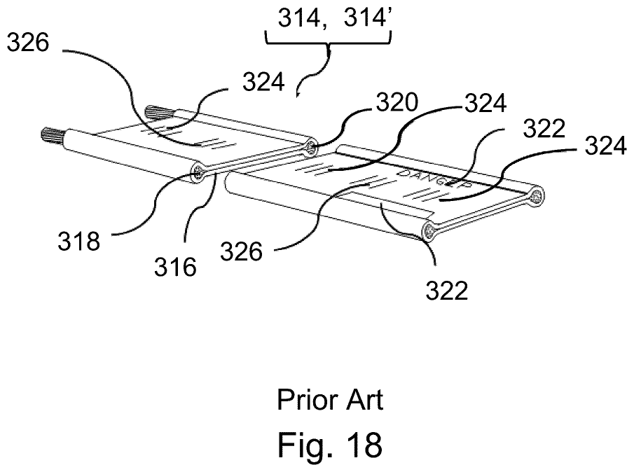

Southworth Jr., in U.S. Pat. No. 3,568,626 [hereinafter “Southworth '626”], discloses an indicator assembly [i.e. marker tape] which is designed to be pulled from the soil when contacted by the bucket or scoop of excavation equipment. FIGS. 16 and 17 [taken from Southworth '626] show a volume of earth 310 containing a buried pipeline 312 or other buried infrastructure which is to be protected from excavation damage by marker tapes 314 and 314′ which are buried respectively a few feet under the surface of earth 310 and a few feet above pipe 312. Marker tapes 314 and 314′ are identical and shown in more detail in FIG. 18 [also taken from Southworth '626].

As shown in FIG. 18 [Taken from Southworth '626], marker tape 314, 314′ is an elongated extensible vinyl sheet 316 folded about two nylon cords 318 and 320 of approximately one-quarter inch [or approximately 0.635 cm] in diameter. The vinyl may, for example, be polyethylene and have the ability to stretch to up to eight times its length before breaking. The nylon cords are preferable stretchable up to three or four times their length. Such materials are described in “The Handbook of Chemistry and Physics,” 41st Edition, published by Chemical Rubber Publishing Company of Cleveland, Ohio. The cords 318 and 320 fit into the longitudinal folds in the sheet 316 so as to form elongated ridges at the edges of the marker tapes 314, 314′. A suitable adhesive on one face of the sheet material 316 secures the cords 318 and 320 in place and holds the edges of the sheet 316 against the central portion of the sheet 316 so as to form the substantially unitary assembly of FIG. 18. When the marker tapes 314, 314′ constitutes the assembly and is buried above a utility line, an operator of automatic excavating equipment, a plow, or a laborer with a shovel, upon hitting the marker tape 314, 314′, starts to bring it up with his implement. In doing so, he can notice the resistance afforded by the marker tape. The latter, in response to the effort of the implement, yields elastically so that a portion of it becomes visible above the portion of the soil being dug. A suitable legend 322 at multiple locations on the surface of the marker tape then apprises the operator of the existence of the utility. The legend 322 in FIG. 18 also includes an indication that the marker tape 314, 314′ has applied thereto magnetic coding signals 324 and radioactive coding signals 326. It instructs the operator that the path of the utility line may be followed by sensing the successive coding signals along its path with suitable sensing equipment above ground.

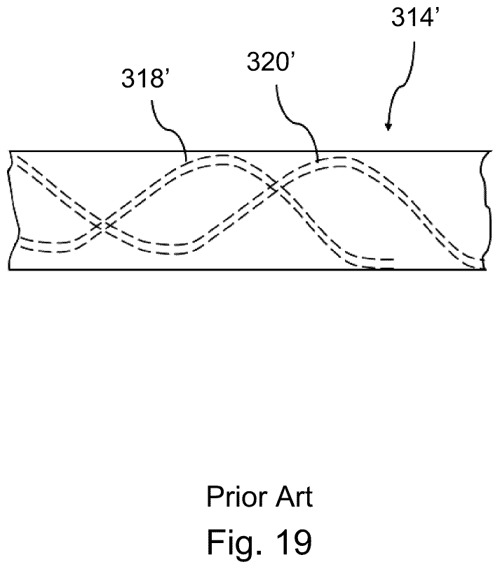

Southworth '626 teaches that the marker tapes 314, 314′ instead of having nylon cords 318, 320 sandwiched only at the edges, may have similar cords 318′, 320′ sandwiched throughout the marker tape as shown in FIG. 19. These cords 318′, 320′ may be in a regular or random pattern. Southworth '626 also teaches that these cords 318′, 320′ may constitute fiberglass or steel strands.

Southworth '626 teaches that his ribbon cords 318, 318′ and 320, 320′ are strong enough to cause the ribbon to be pulled to the surface when encountered by excavation machinery. However, Evett, U.S. Pat. No. 3,908,582 [hereinafter Evett '582] indicates otherwise. Evett '582 teaches that the Southworth tape will have portions of the tape adjacent the trench dug by the excavation equipment sheer before being pulled from highly compacted soil—thus preventing the Southworth tape from being stretched to a readily observable longitudinal extent. The Southworth '626 tape—while intended to be infrangible and of such strength and sufficiently stretchable that a substantial portion of the Southworth tape will be pulled by the excavation machinery to a more observable position—will actually sheer off in the ground. In other words, the prior art recognizes and teaches that Southworth '626 does not provide a marker tape with a core material that is capable of being consistently pulled out of the ground, without breaking, while also, consistently, bringing some, at least, of the remainder of the marker tape to the surface.

### Tracer Wire Technology

Tracer Wire is a well-known method for locating a buried non-metallic utility. A metallic wire [the Tracer Wire] is buried in a known spatial relationship to the buried non-metallic utility. An AC current is then applied to or induced in the buried tracer wire. This AC current in the tracer wire will cause the tracer wire to generate magnetic fields which magnetic fields can then detected [from the surface] using known locating devices. The detector can then locate the tracer wire and “map” the location of the tracer wire. Since the spatial relationship of the tracer wire to the non-metallic underground utility is known-mapping the location of the tracer wire essentially maps the location of the underground utility.

As noted above, tracer wire should be buried in a known spatial relationship to the underground utility. For example, the tracer wire may be buried a few inches [i.e., two in or more —5.1 cm or more] above the underground utility or a few inches [i.e., two in or more —5.1 cm or more] to one side or the other of the underground utility. The tracer wire may also be buried directly on top of the underground utility. The important thing is, whatever spatial relationship the tracer wire has to the underground utility, that spatial relationship must be known. At predetermined intervals along the length of the underground utility, the tracer wire is brought to the surface of the ground or to a manhole or other access port near the surface of the ground so that an electric current may be applied [from the surface] to the tracer wire.

When it is desired to locate the underground utility, the tracer wire is accessed, and an AC current is applied to it at one end and another end of the tracer wire is grounded. This AC current flowing through the tracer wire generates a magnetic signal which is broadcast from the tracer wire. This signal can be remotely detected and mapped from the ground surface using hand-held conventional magnetic locating devices [receivers]. Since the spatial relationship between the tracer wire and the underground utility is known, mapping the tracer wire essentially maps the underground utility.

Several companies sell this type of magnetic locating equipment. For example, the CL 300 Cable Locating Kit from Schonstedt Instrument Company contains a magnetic receiver such as the “Maggie” or the “GA-92XTd” or a similar receiver; a transmitter which can apply an AC current directly to a metallic underground utility and which can also induce an AC current using an inductive clamp, or by remote induction, and the various accessories necessary to map underground utilities or tracer wire.

Using the Schonstedt system, the transmitter can either be electrically connected directly to a metallic underground utility [or to a metallic tracer wire] to induce the desired magnetic fields. In addition, Schonstedt provides an inductive clamp which can be clamped about the underground utility [or the tracer wire] and the transmitter will then induce the desired magnetic fields in the metallic utility or the tracer wire without a direct electrical connection. Lastly, the transmitter has the capability to directly broadcast a varying magnetic field from the surface of the ground, which varying magnetic field will then induce the desired magnetic fields in the buried metallic underground utility or tracer wire. Obviously, this last option is more limited with regard to range and the direct electrical connection is the preferred operating mode. Under ideal conditions, the Schonstedt system can detect underground metallic utilities [or tracer wire] at depths up to 19 feet [or approximately 5.8 m].

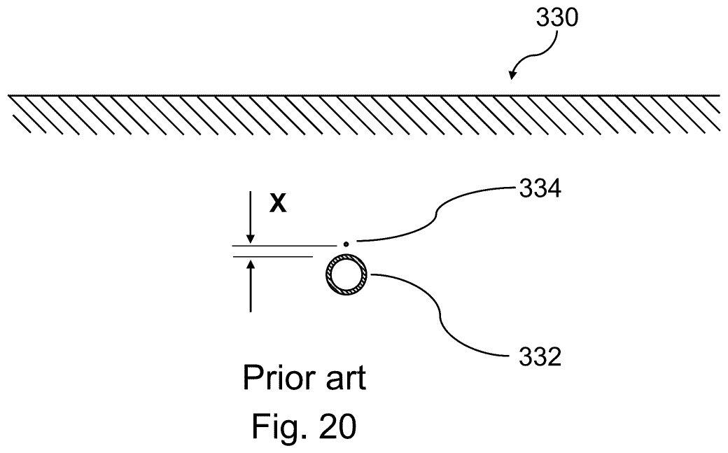

FIG. 20 shows a conventional underground utility 332 with a tracer wire 334 emplaced directly above utility 332. Underground utility 332, in this case a pipe, is buried approximately 2.0 feet [approximately 0.61 m] beneath ground surface 330. As shown by X in FIG. 20, tracer wire 334 is buried approximately 2 to 5 inches [approximately 5.1-12.7 cm] above the top of underground utility 332 and directly over underground utility 332.

It is important that the tracer wire be properly treated to protect it from the underground environment. Broken tracer wire is essentially useless, and tracer wire may be broken in several ways. It may be broken during installation [i.e., burial] or it may be broken after burial. After burial, for example, the tracer wire insulation may break down in the soil and then corrosion of the exposed metallic portion of the wire can cause a break in the wire. If any of these situations develop, it will be impossible to use the wire to map an underground utility. As one source¹ relates, the use of improper protective covering for a copper tracer wire can have disastrous results. If the locality specification for tracer wire only requires the contractor to “Install #12 solid copper wire with jacket” [as many localities do specify] the contractor may well go to the nearest lumber yard or electrical wholesaler and purchase the cheapest #12 solid copper wire available. Often this will be THHN wire or “Thermoplastic, High-Heat-resistant Nylon coated wire. The nylon PVC coating on THHN wire will typically last for about two [2] years underground before it deteriorates and exposes the copper. Bare copper wire, over time, tends to return to its original state, that is, earth. This situation will obviously cause a loss of signal and make it much more difficult [or impossible] to use the tracer wire to locate and map an underground utility. ¹ “Do's and Don'ts of Tracer Wire Systems”, Michael Moore, downloaded from WaterWorld™ at http://www.waterworld.com/articles/2010/09/dos-and-donts-of-tracer-wire-systems. html in February, 2017.

The tracer wire can be easily laid in the desired location with respect to the underground utility if the utility is installed using a trenching method. The tracer wire can also be laid using a Horizontal Directional Drilling system by affixing the tracer wire to the boring head at the same time as the boring head is used for pulling back the underground utility. This is most often done when the underground utility is made from non-metallic materials and thus not easily locatable after burial by known locating and mapping techniques. In this circumstance, it is known to emplace multiple tracer wires along with the underground utility in the hope that one tracer wire, at least, will not break and thus provide a locating signal when needed. When the utility is laid by Horizontal Directional Drilling, the strength of the tracer wire becomes quite important since breakage during pull back is a much greater problem than breakage with a trench laid underground utility. Since normal copper tracer wire does not have high tensile strength, it is sometimes desired to use copper coated steel wire as tracer wire in boring operations. This construction gives much increased strength to the tracer wire with substantially the same conductivity for equivalent sized wires.

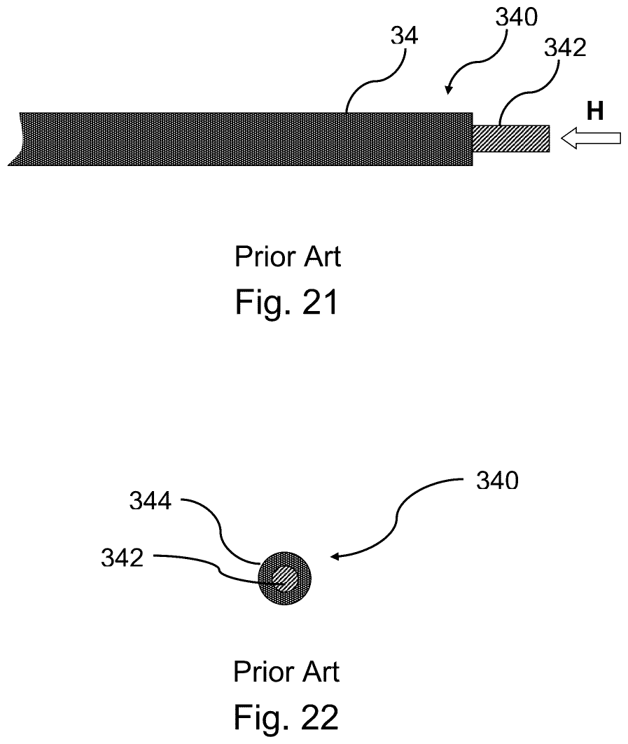

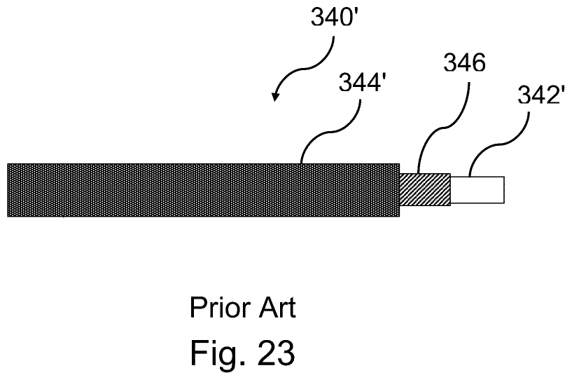

Conventional prior art tracer wire is shown in FIGS. 21 and 22. As shown in FIG. 21, conventional tracer wire 340 may comprise a solid conductive metallic core 342 [e.g., a solid copper core] covered by insulation 344. FIG. 22 shows the conventional tracer wire as a cross-section along arrow H of FIG. 21. A conventional copper coated steel tracer wire 340′ is shown in FIG. 23. Wire 340′comprises a solid steel wire core 342′ coated with copper coating 346 and the whole covered with an insulation layer 344′. It is noted that steel core 342′ may also comprise a multi-stranded wire instead of a solid steel core.

### Rf Markers

Radio Frequency markers [RF markers] are passive devices which are normally used for location purposes only and do not support either unidirectional or bidirectional data transfer between the RF marker and the detection device. They contain a tuned electronic circuit comprising a coupled inductor and capacitor and are designed to resonate when irradiated with an RF electromagnetic signal of a particular frequency. These markers usually do not have a power supply and must derive the energy used to operate from an external source. When irradiated with an RF electromagnetic signal, the RF marker electronic circuit stores electromagnetic energy. When the incoming radiated RF electromagnetic signal is stopped, the RF marker electronic circuit will use the stored energy to rebroadcast the signal at the same frequency as the applied RF electromagnetic signal with an exponentially decaying amplitude. This rebroadcast signal is detected by the locator device and can be used to locate and map the buried RF marker. Even though RF markers are passive and do not support data transfer, it is still possible to use RF markers in such a way that they will provide a rudimentary means of communication between the buried RF marker device and the surface locator. By designing the RF marker to resonate at a particular frequency, and by associating that frequency with a particular type of buried infrastructure [power cable, natural gas pipeline, water pipeline, etc., etc.,] a locator operating at the assigned frequency will only detect an RF marker with the designated frequency which has already been assigned to a particular type of utility. It is known and conventional in this art to have marker tape and RF markers typically assigned color codes according to what type of utility they mark. For example, gas-line markers are yellow; telephone cable markers are orange; wastewater markers are green; water line markers are blue; power supply markers are red. In similar manner, inductive markers are frequently coded by tuning the coil to a particular frequency to represent a particular type of utility. The traditional frequencies are: 83.0 kHz for gas utilities; 101.4 kHz for telecom utilities; 121.6 kHz for wastewater; 145.7 kHz for water utilities; and 169.8 kHz for power utilities. A technician will use a detector tuned to the frequency for the desired utility. For example, if a technician is searching for a gas line, he must use a locator tuned to 83.0 kHz. That locator will activate only inductive markers also tuned to that frequency. Thus, by using RF markers tuned to the resonant frequency associated with the utility which is being marked, it is possible for the passive RF marker to “inform” the locator of what type of utility has been located.

### Rfid Markers

Radio Frequency identification devices [RFID devices] such as those disclosed in Cardullo et al. U.S. Pat. No. 3,713,148 [issued 23 Jan. 1973] are designed to both permit both location and identification of a buried utility. When using a buried RFID device as an infrastructure marker, a base station or surface locator apparatus transmits an “interrogation” electromagnetic signal to the buried RFID device. The buried RFID device then responds with an “answerback” signal. The buried RFID marker includes a changeable or writable memory and means responsive to the transmitted interrogation electromagnetic signal for processing the signal and for selectively writing data into or reading data out from the RFID device memory. The buried RFID device then transmits the answerback signal from the data read-out of its changeable or writable memory. This signal is received and interpreted by the base station or surface locator apparatus. RFID devices normally support both unidirectional and bidirectional data transfer. In other words, the buried RFID device will not only tell the surface locator what type of buried infrastructure it is “protecting” but other desirable information as well. In addition, the surface detector can transmit data to the buried RFID device. RFID markers are similar to RF markers in that they both have an inductor-capacitor circuit which responds to a radiated electromagnetic signal from a surface locator device; however, as noted above, RFID markers have additional electronic components and can perform other functions than merely sending a RF signal to inform of their presence. RFID markers may be semi-passive—that is they have dedicated power supplies which are only turned on when irradiated by a locator RF electromagnetic signal which power supplies may also be augmented by energy transferred by this RF signal. They may also be active devices which have dedicated power supplies which are on all the time. It is obvious that the extra electronics and/or power supplies associated with RFID markers means that they are considerably more expensive than RF markers and also less rugged.

RF and RFID devices can be passive, semi passive or active. Passive devices have no internal power source so all power must be derived from the incoming RF electromagnetic signal using inductive coupling. Semi passive devices have an internal power source which is only active when interrogated by the incoming RF electromagnetic signal [and can be augmented by the incoming RF electromagnetic signal]. Lastly, active devices have a dedicated internal power source.

### Magnetomechanical Marker Technology

It is also possible to mark buried infrastructure using a magnetomechanical marker.

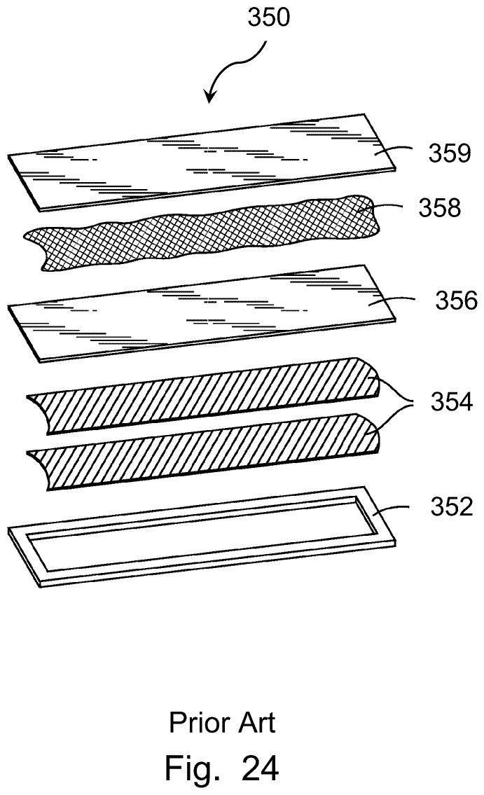

Magnetomechanical markers are passive devices which provide a low cost and very rugged alternative to traditional RF markers. Doany et al. U.S. Pat. No. 9,638,822 issued on 2 May 2017, [hereinafter Doany '822] discloses magnetomechanical markers which can be used to mark a buried utility. FIG. 24 [taken from Doany '822] shows an exploded view of a typical magnetomechanical marker 350. Marker 350 comprises a housing 352, resonator pieces 354, a cover 356 over the resonator pieces 354 and a magnetic bias layer 358 disposed between cover 356 and housing cover 359. Resonator 354 is a ferromagnetic material which has magnetostrictive properties. This means that resonator pieces 354 can deform when exposed to a magnetic field. For example, rapidly alternating magnetostriction causes the iron cores of transformers to hum or buzz. In this example, a magnetic bias layer 358 is emplaced to bias resonator pieces 354. Magnetostrictive marker 350 is resonates at its characteristic frequency when interrogated with an alternating magnetic field tuned to this frequency. Energy is stored in marker 350 during this interrogation period in the form of both magnetic and mechanical energy. The stored mechanical energy is manifested as vibrations in the resonator pieces 354. When the interrogation electromagnetic signal is removed, the resonator pieces continue to vibrate and release significant alternating magnetic energy at the resonator resonant frequency. This alternating magnetic energy can be detected by a suitable surface locator. Housing 352 and housing cover 359 must be strong enough to ensure that the housing can maintain its shape or spacing around resonator pieces 354, allowing sufficient room for resonator pieces 354 to resonate or vibrate. It is possible to use a single resonator piece, two resonator pieces [as shown] or three or more resonator pieces, as desired. In addition, resonator pieces 354 can be designed to resonate at any desired frequency depending primarily upon their length, the strength or the magnetic bias field [generated by magnetic bias layer 358], the density of the resonator material and the Youngs modulus of the resonator material.

As mentioned above, it is very desirable to be able to locate the buried elongated, marked sheath containing the fiber optic cable from the surface after it has been buried underground. To this end, various types of remote locator devices may be incorporated within the elongated, marked sheath. It is also possible to use multiple types of locator devices in the same elongated sheath. For example, it might be desirable to use an elongated tracer wire and spaced RF or RFID devices in a single elongated, marked sheath.

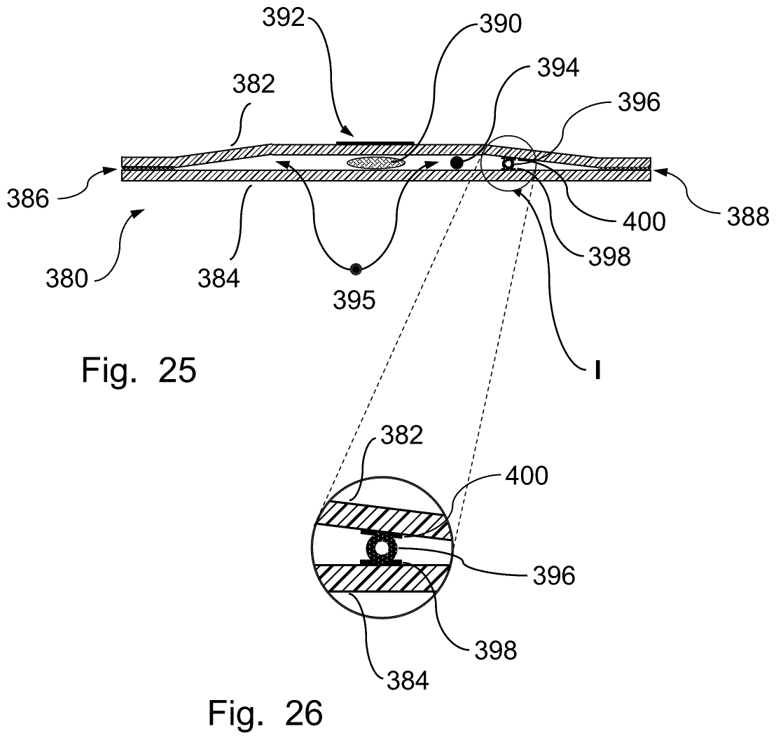

Perhaps the simplest embodiment of the inventive elongated, marked sheath incorporating remote locating devices would be as shown in FIG. 25 where open, envelope-like, elongated, marked protective sheath 380 [hereinafter, open sheath 380] is shown incorporating tracer wire technology. Upper protective material layer 382 [hereinafter “upper layer 382”] and lower protective material layer 384 [hereinafter “lower layer 384”] are joined together at their edges to form open sheath 380. Upper layer 382 preferably comprises a strip of thermoplastic material with a defined width and length, a top surface, a bottom surface and side edge portions at each side of the strip of thermoplastic material on both the top and bottom surfaces thereof. These elements are not shown with reference numerals in FIG. 25 but are readily apparent from the discussion of generic strip terminology which appears above in conjunction with the description of FIG. 4-7. Lower layer 384 also preferably comprises a strip of thermoplastic material with a defined width and length, a top surface, a bottom surface and side edge portions at each side of the strip of thermoplastic material on both the top and bottom surfaces thereof. Upper layer 382 and lower layer 384 are joined together at the side edge portions on the bottom surface of the strip comprising upper layer 382 and the corresponding side edge portions of the upper layer of the strip comprising lower layer 384 with joints indicated as 386 and 388. Thus, the bottom surface of upper layer 382, the top surface of lower layer 384 and the joints 386 and 388 form the boundaries of open sliding space 395. Joints 384, 386 may comprise adhesive layers positioned on at least one of the side edge portions of the bottom surface of the strip comprising upper layer 382 or the side edge portions of the top surface of the strip comprising lower layer 384. Since the strips comprising upper layer 382 and lower layer 384 preferably comprise thermoplastic material, joints 386, 388 may also be made by heat sealing the respective side edge portions together or by ultrasonically welding the respective side edge portions together. It is noted that any other suitable joining method may be used to join the preferably thermoplastic strips comprising layers 382, 384. It is also possible to extrude these layers together in an extrusion process which is not shown in the drawings. Also shown in FIG. 25 is elongated core material 390 which is not fastened to either of the strips comprising upper layer 382 or lower layer 384. Elongated core material 390 must slide within elongated sheath 380. In addition, a fiber optic cable 394 is shown to the right of elongated core material 390 in FIG. 25. While it is not apparent from FIG. 25, elongated core material 390 and fiber optic cable 394 would both be long enough to extend, and would extend, at least slightly, from each end of elongated sheath 380. In addition, anti-theft indicia 392 is also shown imprinted upon the outer [top] surface of the strip comprising upper layer 382.

In the embodiment shown in FIG. 25, open sheath 380 contains a slidable elongated core material 390, a fiber optic cable 394 and an elongated tracer wire 396. As noted above, elongated core material 390 is not secured to open sheath 380 since it must slide freely therein in order to function as required [see the disclosure above in regard to FIGS. 1 and 2]. Fiber optic cable 394 would also normally not be secured to open sheath 380 but merely be positioned within open sheath 380; to one side or the other of elongated core material 390. However, unlike the situation with elongated core material 390, there is no reason why fiber optic cable 394 can not be secured to open sheath 380, if this is desired or necessary for a particular application. It is envisioned that elongated tracer wire 396 would be secured to open sheath 380. It is desirable that tracer wire 396 be installed within open sheath 380 in a generally straight configuration since tracer wire functions better with such an installation. Keeping in mind the fact that it is intended to pull fiber optic cable into and through open sheath 380 using slidable, elongated core material 390, it is envisioned that elongated marker wire 396 would be secured to at least one of the lower surface of the strip comprising upper layer 382 or the upper surface of the strip comprising lower layer 384—or both. Elongated tracer wire 396 is shown in FIG. 25 as being secured to both the lower surface of the strip comprising upper layer 382 and the upper surface of the strip comprising lower layer 384 by adhesive means comprising adhesive strips. During assembly of open sheath 380, adhesive strip 398 is laid on the upper surface of the strip comprising lower layer 384 and adhesive strip 400 is laid on the lower surface of the strip comprising upper layer 382. Elongated tracer wire 396 is positioned between these two adhesive strips so as to be secured to open sheath 380.

A blown-up view of this installation of elongated marker wire 396 is shown in FIG. 26. FIG. 26 shows a blown-up view of section I of FIG. 25. The strips comprising upper layer 382 and lower layer 384 are shown in cross-section with a strip of adhesive 400 being applied to the lower surface of the strip comprising upper layer 382 and a strip of adhesive 398 being applied to the upper surface of the strip comprising lower layer 384. Elongated tracer wire 396 is shown adhered to both adhesive strips 398, 400. Although adhesive is shown as the preferred means to secure elongated marker wire 396 to open sheath 380 it is obvious that any other suitable securing means could also be used. For example, since it is envisioned that the strips comprising upper and lower layers 382, 384 will comprise thermoplastic materials, it is possible to use a form of heat sealing or ultrasonic welding to secure elongated tracer wire 396 to open sheath 380, with the thermoplastic material of the strips themselves providing the necessary adhesive material when subjected to heat or an ultrasonic welding treatment. Any suitable means could be used to secure elongated tracer wire 396.

It is also possible to secure elongated tracer wire 396 by positioning it within joint area 386 or 388 and having whatever securing means is used to join the side edge portions of upper layer 382 and lower layer 384 firmly secure elongated tracer wire 396 within open sheath 380. It is noted that this construction is not shown in the drawings.

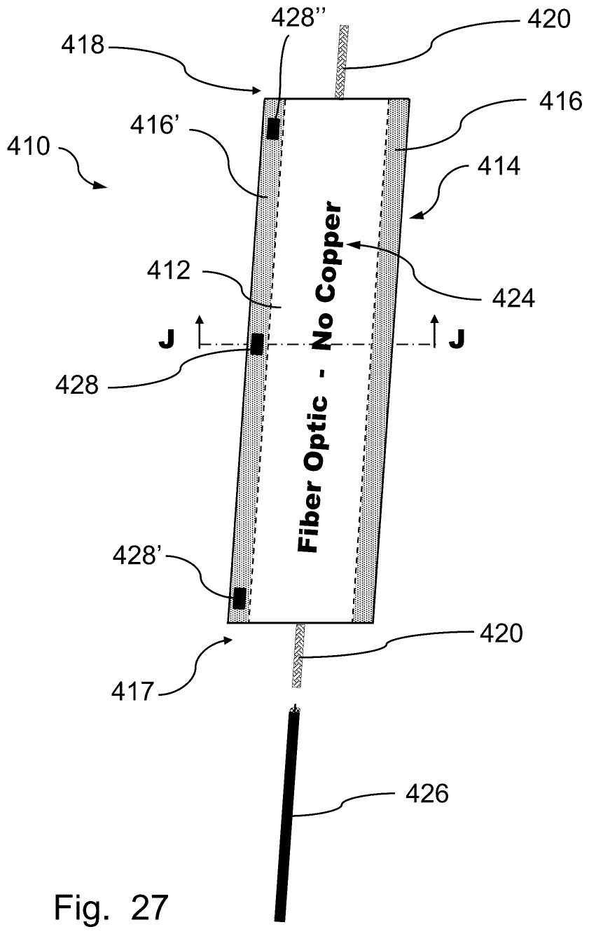

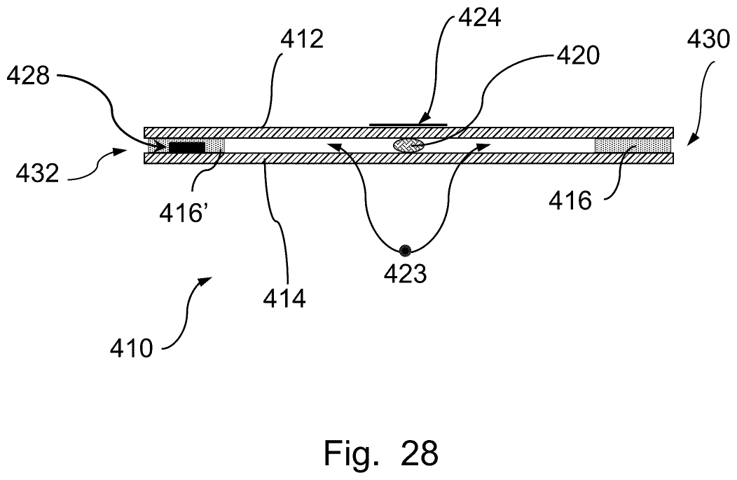

It is also possible to use other types of remote locating means different from tracer wire in the inventive elongated, marked sheath. For example, as shown in FIGS. 27 and 28, spaced remote locating devices 428, 428′ and 428″ are shown incorporated within adhesive layer 416′ of envelope-like, open, elongated, marked sheath 410 [hereinafter “open sheath 410]. It is noted that open sheath 410 is much longer than it is wide and that remote locating means 428, 428′ and 428″ are spaced throughout the length of open sheath 410 at spacing intervals as suggested by the manufacturer of the remote locating means. Open sheath 410 comprises an upper strip 412 joined to a lower strip 414 by adhesive layers 416, 416′ at joints 430, 432, respectively. It is noted that lower strip 414 is not visible in FIG. 27 but is clearly shown in FIG. 28 which is a cross-sectional view of open sheath 410 shown from the point of view of section line J-J of FIG. 27. Adhesive layer 416 is shown as being [on the right in FIG. 28] between the side edge portion of the lower surface of upper strip 412 and the side edge portion of the upper surface of lower strip 414. Adhesive layer 416′ is shown as being [on the left side of FIG. 28] between the side edge portion of the lower surface of upper strip 412 and the side edge portion of the lower strip 414. As is similar to the showing in FIG. 1, elongated sheath 410 has an open proximal end 417 and an open distal end 418. Elongated core material 420 is enclosed within open sheath 410 in open sliding space 423 formed therein by the joining of upper strip 412 and lower strip 414. Thus, elongated core material 420 can freely slide along the length of open sheath 410. This is so that a length of fiber optic cable 426 may be pulled into open proximal end 417 of open sheath 410 and through open sheath 410 by tying the exposed end of elongated core material 420 to the end of fiber optic cable 426 and by pulling elongated core material 420 into proximal end 417 of open sheath 410, through open sliding space 423 therein and out of the distal end 418. It is also noted that anti-theft indicia 424 is imprinted on the top surface of upper layer 412.

It is noted that remote locating means 428, 428′ and 428″ shown in FIG. 27 may be any suitable type of remote locating means such as, for example, RF tags, RFID tags, magnetic markers, radioactive markers, or simple ferrous metallic pieces to name a non-exhaustive listing of possibilities.

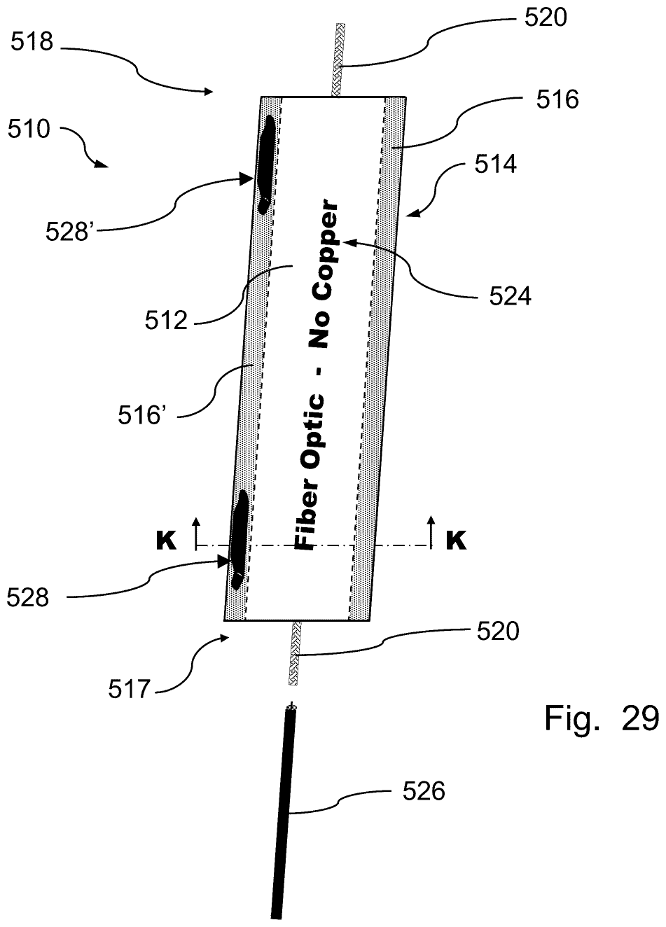

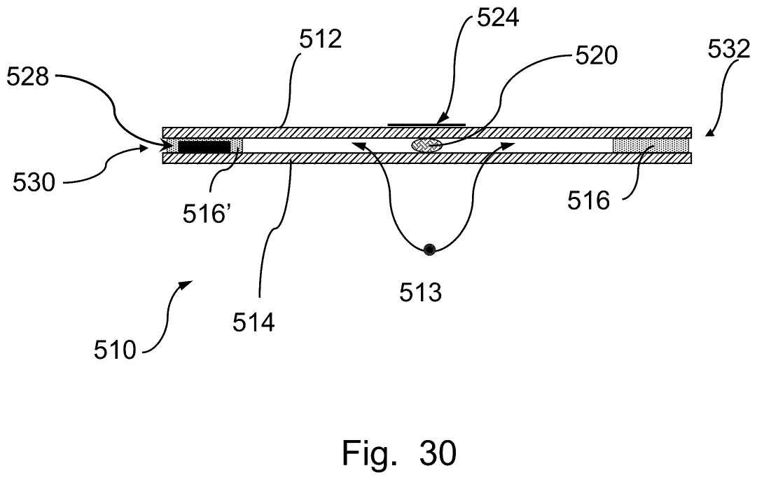

It is noted that the remote locating means used in the elongated, marked strip of the invention may be a magnetomechanical locating means. This type of locator device is shown in FIG. 24 and was discussed above. FIGS. 29 and 30 illustrate the inventive open, envelope-like, elongated, marked sheath 510 [hereinafter “open sheath 510] incorporating multiple spaced magnetomechanical markers 528, 528′. FIG. 30 is a cross-sectional view of open sheath 510 taken from the point of view of section K-K in FIG. 29. Open sheath 510 comprises upper layer 512 and lower layer 514 joined together at joints 530, 532. It is noted that upper layer 512 and lower layer 514 each comprise strips with a top surface and a bottom surfacer and side edge portions at each side of the top and bottom surfaces of the strips. It is noted that open sheath 510 is much longer than it is wide and that magnetomechanical locating means 528 and 528′ are spaced throughout the length of open sheath 510 at spaced intervals as suggested by the manufacturer of the magnetomechanical locating means. It is noted that lower layer 514 is not visible in FIG. 29 but is clearly shown in FIG. 30. Adhesive layer 516 is shown as being [on the right in FIG. 30] between the side edge portion of the lower surface of upper layer 512 and the side edge portion of the upper surface of lower layer 514. Adhesive layer 516′ is shown as being [on the left side of FIG. 30] between the side edge portion of the lower surface of upper layer 512 and the side edge portion of the lower layer 514. As is similar to the showing in FIG. 1, open sheath 510 has an open proximal end 517 and an open distal end 518 connected by open sliding space 513 formed by the bottom surface of the strip comprising upper layer 512, the top surface of the strip comprising lower layer 514 and adhesive strips 516, 516′. Elongated core material 520 is enclosed within open sheath 510 so that it can freely slide through open sliding space 513. This is so that a length of fiber optic cable 526 may be pulled into open proximal end 517 of open sheath 510 and through open sliding space 513 of open sheath 510 by tying the exposed end of elongated core material 520 to the end of fiber optic cable 526 and by pulling elongated core material 520 through open sheath 510 and out of distal end 518. It is also noted that anti-theft indicia 524 is imprinted on the top surface of upper layer 512. Magnetomechanical markers 528, 528′ are enclosed within adhesive strip 516′ as shown in FIG. 30.

Although adhesive strips 516, 516′ are shown in FIGS. 29 and 30 as the means used to secure upper layer 512 to lower layer 514 it is obvious that any other suitable securing means could also be used. For example, since it is envisioned that the strips comprising upper and lower layers 512, 514 will preferably comprise thermoplastic materials, it is possible to use a form of heat sealing or ultrasonic welding to secure upper layer 512 to lower layer 514 at joints 530, 532, with the thermoplastic material of the strips themselves providing the necessary adhesive material when subjected to heat or an ultrasonic welding treatment. Any suitable means could be used to secure upper layer 512 and lower layer 514 together.

It is also possible, as discussed above, to make an embodiment of the envelope-like, elongated, marked sheath which has an upper layer joined to a significantly wider lower layer as is illustrated in FIGS. 31 and 32. Open, envelope-like elongated, marked sheath 550 [hereinafter open sheath 550] comprises upper layer 552 and lower layer 554 joined together by adhesive layers 556, 556′. As shown in FIGS. 31 and 32, lower layer 554 is significantly wider than upper layer 552. In FIG. 31and 32 lower layer 554 is shown as being approximately twice as wide as upper layer 552 although this relationship is not limiting and the width ratios could be larger or smaller, as desired, for the particular application. Upper layer 552 is shown as being approximately positioned in the middle of lower layer 554 and secured thereto by adhesive layers 556, 556′. It is noted that it is possible to emplace warning indicia on the exposed upper surface of wider lower layer 554, for example, the surface could have broad diagonal stripes emplaced thereon [not shown in the drawings] to call attention to open sheath 550. Since the upper surface of upper layer 552 already has anti-theft indicia 564 emplaced thereon, it would probably not be desirable to emplace additional indicia on this surface; however, it is envisioned that there may be circumstances where placement of additional warning indicia on the upper surface of upper layer 552 would be desirable. It would obviously be desirable in this circumstance, to not obscure anti-theft indicia 564 with this added warning indicia. As is shown above with respect to previous embodiments, open sheath 550 has an open proximal end 557 and an open distal end 558 as shown in FIG. 31. Upper layer 552 and lower layer 554 are formed from elongated strips which each have a top surface, a bottom, surface and side edge portions at each side of the top and bottom surfaces thereof. Open sliding space 553 is formed by the bottom surface the strip comprising upper layer 552, the top surface of the strip comprising lower layer 554 and adhesive strips 556, 556′. Elongated core material 560 is slidably contained within open sliding space 553 and extends somewhat from both proximal end 557 and distal end 558 of elongated sheath 550. Also as with previous embodiments, fiber optic cable 562 is shown positioned near the end of elongated core material 560 extending from proximal end 557 of elongated sheath 550. Anti-theft indicia 564 is imprinted upon upper surface of upper layer 552 as shown in FIGS. 31 and 32. Spaced remote locating means 568, 568′ and 568″ are emplaced within adhesive layer 556′ as shown in FIGS. 31 and 32. These remote locating means could be of any type disclosed herein or any other suitable remote locating means. It is noted that open sheath 550 is much longer than it is wide and that remote locating means 568, 568′ and 568″ are spaced throughout the length of open sheath 550 at spacing intervals as suggested by the manufacturer of the remote locating means. Elongated core material 560 is enclosed within open sheath 550 so that it can freely slide along the length of open sliding space 553. This is so that a length of fiber optic cable 562 may be pulled into open proximal end 557 of elongated sheath 550 and through open sliding space 553 by tying the exposed end of elongated core material 560 to the end of fiber optic cable 562 and by pulling elongated core material 560 through the open sliding space 553 and out of distal end 558.

It is noted that remote locating means 568, 568′ and 568″ shown in FIGS. 31 and 32 may be any suitable type of remote locating means such as, for example, RF tags, RFID tags, magnetic markers, radioactive markers, or simple ferrous metallic pieces to name a non-exhaustive listing of possibilities.

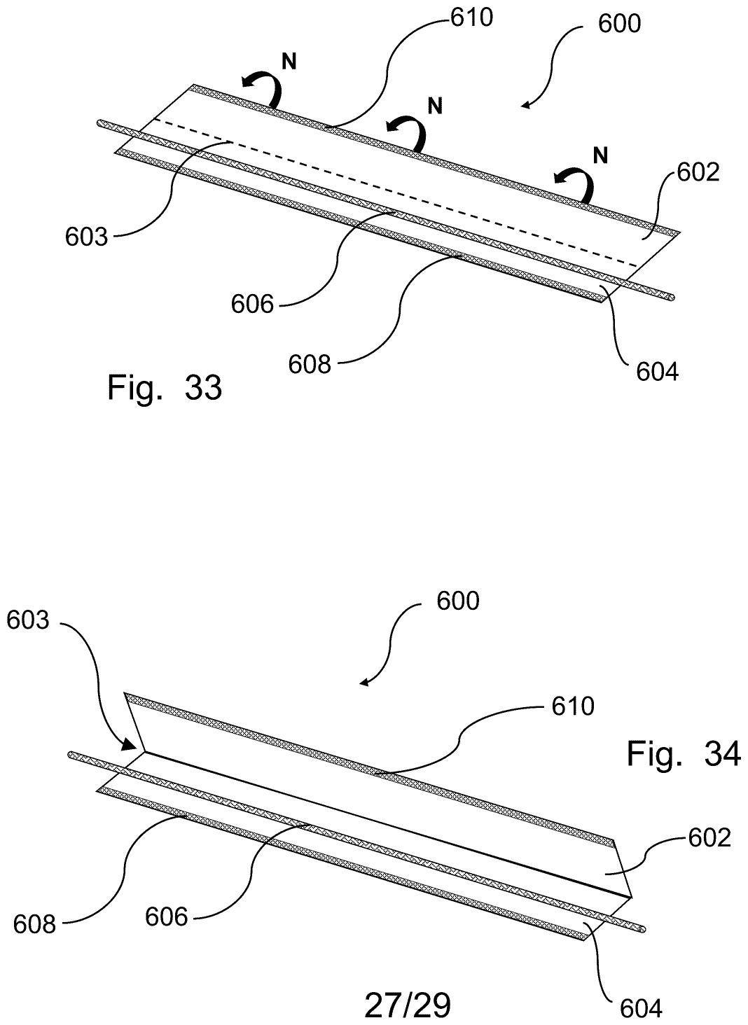

FIG. 33-38 show how the inventive open elongated sheath may be made by folding a single strip.

FIG. 33 shows strip 600 laid out in a flat configuration prior to folding. Strip 600 is approximately twice as wide as the desired width of the finished open, elongated sheath. Strip 600 has an imaginary centerline 603 illustrated by a dashed line since it is imaginary. Centerline 603 divides strip 600 into a right hand portion 602 and a left hand portion 604. Elongated core material 606 is placed approximately in the middle of left hand portion 604. Adhesive strips 608 and 610 are placed at the side edge portions of the upper surface of strip 600. Curved arrows N illustrate the direction of the folding action which is used to form the finished open, elongated sheath. It is noted that the angle between right hand portion 602 and left hand portion 604 is approximately 180° in FIG. 33.

FIG. 34 shows strip 600 partly folded in the direction of arrows N. The angle between right hand portion 602 and left hand portion 604 is shown as approximately 85° in FIG. 34.

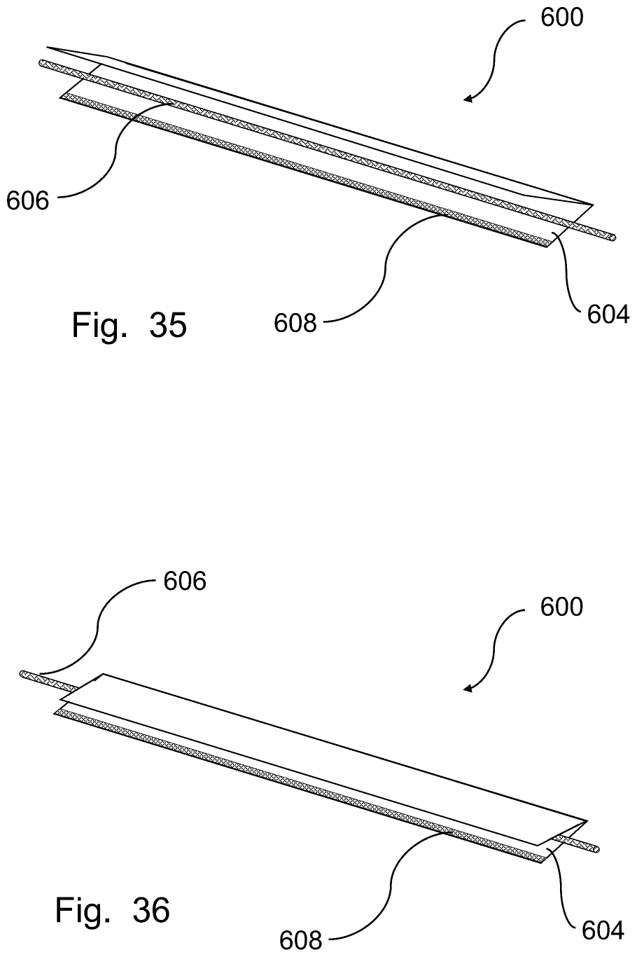

FIG. 35 shows strip 600 folded to a greater extent than the showing of FIG. 34. The angle between right hand portion 602 and left hand portion 604 is shown as approximately 45° in FIG. 35.

FIG. 36 shows strip 600 folded to a greater extent than the showing of FIG. 35. The angle between right hand portion 602 and left hand portion 604 is shown as approximately 20° in FIG. 35.

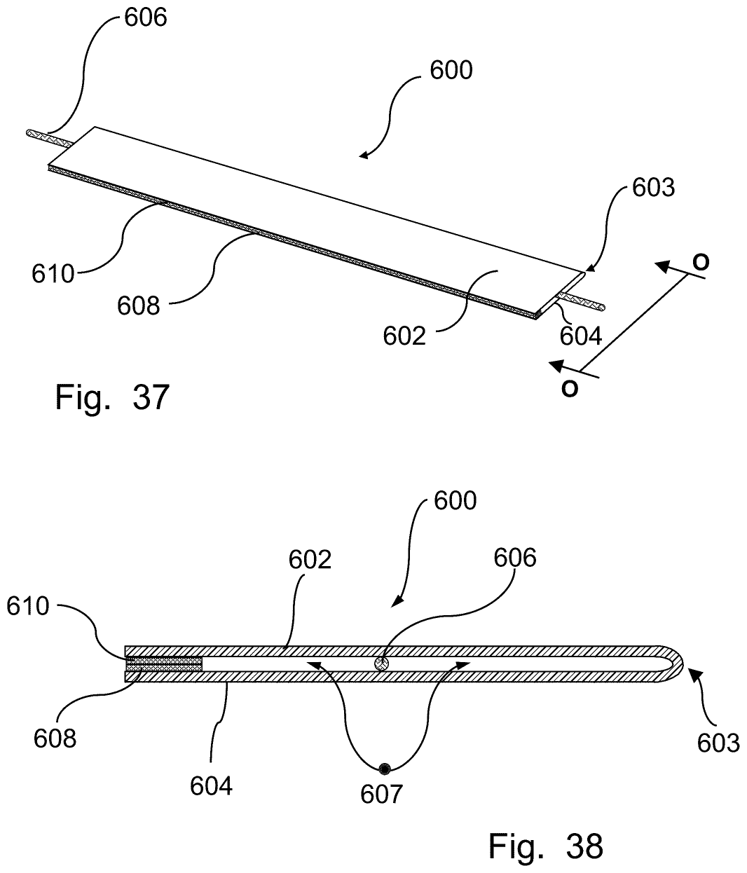

FIG. 37 shows strip 600 completely folded to form the open, elongated sheath. The angle between right hand portion 602 and left hand portion 604 is shown as approximately 0° in FIG. 37.

FIG. 38 shows an end view of the open, elongated sheath of FIG. 37 taken along the section line O-O of FIG. 37. Folded strip 600 now forms an open, elongated sheath with right hand portion 602 forming the upper layer of the open, elongated sheath and lower layer 604 forming the lower layer of the open, elongated sheath. Adhesive layers 608 and 610 are joined at the left side of folded strip 600 to provide a tight joint. The right side of folded strip 600 comprises the area of strip 600 near centerline 603. There is no adhesive at this side, nor is any needed. Elongated core material 606 is encased within folded strip 600 in open sliding space 607 formed by the opposed surfaces of right hand portion 602 and left hand portion 604 as shown in FIG. 38. In this manner, an open, elongated sheath can be formed by folding a single strip.

It has also been found to be very useful to treat the exposed surfaces of the upper and lower protective layers of the inventive open, elongated, marked sheath and their exposed edges so that they are hydrophobic. This means that soil and etc. will not stick to the exposed protective layers and thus, that they will be more visible in and out of the ground. It has also been found useful to treat the insulation layer of any marker wire installed in the elongated, marked sheath so that it emits light when an electric current is run through the wire. It is possible to position diodes in the insulation to glow when an electric current is passed through the wire. It may well be desirable to provide known special security reflective devices similar to those frequently used with state driver's licenses and/or vehicle license plates to provide additional visibility for the inventive open, elongated, marked sheath.

It is also noted that depiction, using two-dimensional drawings, of elongated strips which may be hundreds [or thousands] of feet long while having a width which is of the order of one or two feet is not an easy task and, therefore, it is to be noted that the depiction of the width of the inventive open, elongated, marked sheath in relation to the length thereof has been greatly exaggerated for clarity in the drawings. It is also to be noted that the thermoplastic materials which are preferably used for the upper and lower layers of the inventive protective material sheaths are quite thin in relation to their actual width [and length] in the inventive open, elongated, marked sheath. Therefor, the depiction of the thickness of, say upper layer 552 and lower layer 554, as presented in the drawings [for example, in FIG. 32] in proportion to the width of layers 552, 554 shown in the drawings is grossly exaggerated. For example, as noted above, the thickness of the thermoplastic material comprising upper layer 552 and lower layer 554 is of the order of 0.001-0.002 inches [0.00254-0.00508 cm] although other thicknesses may be used, as desired and/or necessary. The width of layer 552, for example, as shown in FIG. 32 is approximately 4 inches [10 cm] while the width of layer 554 may be approximately 8 inches [approximately 20.3 cm]. Thus, a true scale rendering of the inventive sheath would mean that the true thickness of upper layer 512 [0.001-0.002 inches [0.00254-0.00508 cm] would mean that upper layer 512 would be almost invisible in any drawing. Instead of that situation, the thickness of layer 512 in the drawings has been exaggerated with respect to its width such that the drawings are legible and convey useful information about the inventive open, elongated, marked sheath. This is what applicants mean by exaggeration for clarity.

1. A detectable, open, elongated protective sheath comprising protective material, an elongated core material and at least one remote locating device:
said detectable, open, elongated protective sheath further comprising an open envelope-like structure having, an open proximal end and an open distal end, with an open sliding space connecting said open proximal end and said open distal end, and further having a first length and a first width with said first length being much longer than said first width is wide;
said protective material further comprising;
an upper protective material layer comprising a first strip having
a second length,
a first top surface and a first bottom surface,
a side edge portion along each side of said first strip on both said first top surface and said first bottom surface; and,
a second width,
with said second length being much longer than said second width is wide;
a lower protective material layer comprising a second strip having
a third length,
a second top surface and a second bottom surface,
a side edge portion along each side of said second strip on both said second top surface and said second bottom surface; and,
a third width,
with said third length being much longer than said third width is wide;
with said first strip and said second strip being superposed and secured together at the side edges of said strips to form said open sliding space, of said detectable, open, elongated protective sheath;
an elongated core material positioned in said open sliding space between said first bottom surface and said second top surface such that said elongated core material may freely slide along the lengths of said first and said second strips, with said elongated core material having a fourth length with said fourth length being slightly longer than said second length;
said at least one remote locating device being positioned between said first bottom surface and said second top surface such that said at least one remote locating device is enclosed within said detectable, open, elongated protective sheath.

2. The detectable, open, elongated protective sheath of claim 1 wherein said second and said third lengths are substantially equal and said second and said third widths are substantially equal, with said with said first strip and said second strip being secured together by securing means positioned at said side edge portions of said first bottom surface and said side edge portions of said second top surface to form said open sliding space of said detectable, open, elongated protective sheath.

3. The detectable, open, elongated protective sheath of claim 2 wherein a length of fiber optic cable is positioned between said first bottom surface and said second top surface and to one side of said elongated core material, with said fiber optic cable having a fifth length, with said fifth length being slightly longer than said second length.

4. The detectable, open, elongated protective sheath of claim 1 wherein anti-theft indicia is imprinted on said first top surface.

5. The detectable, open, elongated protective sheath of claim 4 wherein said anti-theft indicia indicates that the detectable, open, elongated protective sheath contains fiber optic cable and does not contain copper.

6. The detectable, open, elongated protective sheath of claim 1 wherein said first strip and said second strip are secured together by adhesive layers along said side edge portions of said first bottom surface and along said side edge portions of said second top surface.

7. The detectable, open, elongated protective sheath of claim 1 wherein said first strip and said second strip comprise thermoplastic materials and are secured together by heat sealing said side edge portions of said first bottom surface and said side edge portions of said second top surface together.

8. The detectable, open, elongated protective sheath of claim 1 wherein said first strip and said second strip comprise thermoplastic materials and are secured together by ultrasonic welding said side edge portions of said first bottom surface and said side edge portions of said second top surface together.

9. The detectable, open, elongated protective sheath of claim 1 wherein at least one portion of said first strip is transparent and wherein anti-theft indicia is reverse imprinted on said first bottom surface so as to be visible through said at least one transparent portion.

10. The detectable, open, elongated protective sheath of claim 9 wherein said anti-theft indicia indicates that the open, elongated protective sheath contains fiber optic cable and does not contain copper.

11. The detectable, open, elongated protective sheath of claim 1 wherein at least one portion of said second strip is transparent and wherein anti-theft indicia is reverse imprinted on said second top surface so as to be visible through said at least one transparent portion, with said indicia indicating that said open, elongated, protective sheath contains fiber optic cable and does not contain copper.

12. The detectable, open, elongated protective sheath of claim 1 wherein anti-theft indicia is imprinted on said first top surface and said second bottom surface, said indicia indicating that said open, elongated, protective sheath contains fiber optic cable and does not contain copper.

13. The detectable, open, elongated protective sheath of claim 1 wherein said at least one remote locating device comprises at least one of the following: tracer wire, RF tags, RFID tags, magnetic tags, radioactive tags, ferrous metal tags, and magnetomechanical devices.

14. The detectable, open, elongated protective sheath of claim 2 wherein said at least one remote locating device further comprises at least two spaced remote locating devices selected from the following: RF tags, RFID tags, magnetic tags, radioactive tags, ferrous metal tags, and magnetomechanical devices.

15. The detectable, open, elongated protective sheath of claim 14 wherein said at least two spaced remote locating devices are encased within said securing means.

16. The detectable, open, elongated protective sheath of claim 1 wherein said second and said third lengths are substantially equal and said second and said third widths are substantially equal.

17. The detectable, open, elongated protective sheath of claim 1 wherein said second and third lengths are substantially equal and said second and said third widths are not equal.

18. The detectable, open, elongated protective sheath of claim 17 wherein said third width is substantially twice as wide as said second width with said first strip being positioned substantially in the middle of the top surface of said second strip.

19. The detectable, open, elongated protective sheath of claim 18 wherein anti-theft indicia is imprinted on said first top surface.

20. The detectable, open, elongated protective sheath of claim 19 wherein said anti-theft indicia indicates that the open, detectable, elongated protective sheath contains fiber optic cable and does not contain copper.

21. A detectable, open, elongated protective sheath comprising protective material, an elongated core material and at least one remote locating device:
said detectable, open, elongated protective sheath further comprising an open envelope-like structure having, an open proximal end and an open distal end with an open sliding space connecting said open proximal end and said open distal end, and further having a first length and a first width with said first length being much longer than said first width is wide;
said protective material further comprising;
a strip having;
a second length,
a first top surface and a first bottom surface,
a side edge portion along each side of said strip on both said first top surface and said first bottom surface;
a longitudinal center line dividing said top surface of said strip into a top right hand portion and a top left hand portions; and,
a second width,
with said second width being substantially twice the width of said first width,
with said second length being much longer than said second width is wide;
wherein said open envelope-like structure is formed by folding said strip about said longitudinal center line, bringing said top right hand portion of said top surface of said strip into opposed contact with said top left hand portion of said top surface of said strip and securing said side edge portions on said top surface of said strip together, at one side of said folded strip so as to form said open envelope-like structure, with the opposed, folded right and left hand portions of said top surface of said strip forming said open sliding space of said open envelope-like structure and said folded bottom surface of said strip forming the outside surfaces of said open envelope-like structure;
with an elongated core material positioned between said opposed and folded right hand portion of said top surface of said strip and said left hand portion of said top surface of said strip, wherein said elongated core material is free to slide within said envelope-like structure;
said detectable, elongated protective sheath further comprising at least one remote locating means secured within said envelope-like structure.

22. The detectable, open, elongated protective sheath of claim 21 wherein anti-theft indicia is imprinted on said bottom surface of said strip.

23. The detectable, open, elongated protective sheath of claim 22 wherein said anti-theft indicia indicates that the detectable, elongated protective sheath contains fiber optic cable and does not contain copper.

24. The detectable, open elongated protective e sheath of claim 21 wherein said at least one remote locating device comprises at least one of the following: tracer wire, RF tags, RFID tags, magnetic tags, radioactive tags, ferrous metal tags, and magnetomechanical devices.
